(19) United States
(12) Patent Application Publication
(10) Pub. No.: US 2007/0154172 A1
(43) Pub. Date: Jul. 5, 2007

(54) RECORDING AND REPRODUCTION APPARATUS

(75) Inventor: Shigeaki Watanabe, Osaka, NJ (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/612,126

(22) Filed: Dec. 18, 2006

Related U.S. Application Data
(60) Provisional application No. 60/751,375, filed on Dec. 19, 2005.

(51) Int. Cl. H04N 5/91

(52) U.S. Cl. 386/83

(57) ABSTRACT

With time buffer reproduction, which uses a fixed-length ring buffer, it is necessary to forcefully change the reproduction position in the case where reproduction is paused and the recording position within the ring buffer makes a revolution around the ring buffer and reaches the position of reproduction, and thus the pause function has no meaning. The present invention provides a time-shift buffer in which the recording position does not reach the reproduction position, by sequentially creating plural buffer areas in accordance with the recording progress and deleting the buffer areas in accordance with the reproduction progress.

### CROSS REFERENCE TO RELATED APPLICATION

This application claims the benefit of U.S. Provisional Application No. 60/751,375, filed Dec. 19, 2005, the contents of which are herein incorporated by reference in its entirety.

### BACKGROUND OF THE INVENTION

(1) Field of the Invention

The present invention relates to a recording and reproduction apparatus which accumulates content and reproduces the accumulated content. In particular, the present invention relates to a setup for receiving a content made up of data such as video, audio, and a program that are mutually synchronized, multiplexed with a broadcast wave, and sent, in which the broadcast wave is received and the video, audio, and data is accumulated, as well as a setup for reproducing the content while maintaining synchronization between the video/audio and the data such as a program.

(2) Description of the Related Art

Various content is included in a broadcast wave sent from a broadcasting station. Aside from video and audio used in a normal television program, there are cases where data is included in the content. There are several methods for sending the data, which can be roughly divided into a method of sending the data chronologically and a method of repeatedly sending the data per set interval. In the former method of sending the data chronologically, for example, data that continues over the course of time is sent in sequential order. This method is suitable for sending large amounts of data over a long period of time, but there is a drawback in that data that could not be received at the time of the send cannot be received again. On the other hand, in the latter method of repeatedly sending the data at a set interval, the same data is repeatedly sent any number of times during a fixed period. This method has an advantage in that during the period when the same data is being sent, it is acceptable to receive any one of the repeatedly-sent pieces of data, and thus the timing of receiving is not limited. Data broadcast, represented by BML, and file sending through DSM-CC data carousel are examples of this method. It is unknown, particularly in broadcast, exactly when a recipient will select a channel, thereby commencing reception. In the method of sending the data chronologically, when the reception is commenced after the send has been performed and thus acquisition of the data fails, the data cannot be re-acquired. Therefore, when sending data such as an application program along with video and audio in the broadcast wave, the method of repeatedly sending the data per set interval is favorable.

At present, specifications for receiving a broadcast wave that includes video, audio, and an application program and executing the application program in synchronization with video and audio, as in the above method, have been developed, and are in operation. It is possible to receive the sent application program, import the application program into a terminal, and implement various extra functions by executing the application program, rather than simply viewing the video and audio. This method for sending the application program and importing it into the terminal is also called “downloading.” As an example, a specification called Digital Video Broadcasting—Multimedia Home Platform (DVB-MIHP) ETSIES201812 v1.1.1 (2003-12) has been developed in Europe, and operations according to this specification have already commenced, In addition, the Open Cable Application Platform (OCAP) OC-SP-OCAP 1.0-I16-050803 specification, which provides the same framework in the cable broadcast environment, is being developed in the United States, and actual operations are set to commence. In these specifications, the application program is written in the Java language. Various Application Programming Interfaces (APIs) for tuning, graphics display, and the like are provided in the terminal, and the Java application program can control those functions by calling the APIs.

In addition, in North America, the OCAP-DVROC-SP-OCAP-DVR-I02-050524 specification, which aims to adding functions for recording and reproducing the content in the OCAP specification, is being developed. This specification collectively defines the video, audio, and Java application program synchronized thereto and executed, which are sent as a cable television broadcast, as a service. A service can be recorded as content, and a recorded service may be reproduced in the same manner as when directly reproducing a broadcast signal. The application program is reproduced in synchronization with the video and audio, in the same manner as direct reproduction from the broadcast wave.

In addition, with OCAP-DVR, delayed reproduction of services is implemented by recording a broadcasted service onto a high-speed random access storage medium, such as a hard disc or a solid-state memory, while reading out and reproducing the already-recorded portion of the service at a time delay. This function is generally known as “chase playback” or “time-shift playback.” To put it simply, this function reproduces the service not at the time it was broadcasted but at a time later than when it was broadcasted. Furthermore, trick play of content is implemented by making it possible to vary the playback position, playback speed, and the like of a recorded service. Here, “trick play” refers to functions for reproducing the content at an arbitrary speed, from an arbitrary position, and so on; such functions include fast-forward, rewind, slow-motion, pause, skip, and the like. With OCAP-DVR, the application program imported into the terminal from the broadcast wave can control the recording and trick play of the content. In other words, APIs for recording, trick play, and so on are provided in the terminal, and the Java application program controls each function by calling those APIs

In time-shift playback, a recording area known as a time-shift buffer is secured for use in storing content; the service is recorded into the time-shift buffer, and the service is reproduced. There are cases where a recording area called a “ring buffer” is set in the storage device as the time-shift buffer. This ring buffer is generally a fixed-length serial region for recording secured in the storage device. When recording content, the content is written from the start toward the end of the serial region. When content has been written up to the end of the serial region, the write position returns to the start of the serial region, and the content is once again written from the start toward the end of the serial region. Accordingly, when the content is written from the start of the serial region for the second time, the content already present in the serial region is overwritten. By recording in such a manner, it is possible to continuously hold broadcasted content for a fixed period of time, and thus it is possible to return to the start of the content being held and commence playback from that point.

When a fixed-length ring buffer is utilized as the time-shift buffer, and when trick play of content recorded into the ring buffer is performed, problems arise during recording when the writing begins again from the start of the serial region and the write position hits the read position of the content being reproduced. The information recording and reproduction apparatus with ring buffer disclosed in Japanese Patent Application No. 2000-367979 (P2000-367979) solves this problem. That is, the reproduction speed is forcibly sped up when the reproduction (read) position at the current point in time in is past the record (write) position in the ring buffer and the record speed at the current point in time is faster than the playback speed. Through this, overwriting areas scheduled for time-shift playback can be prevented.

However, with the solution presented by Japanese Patent Application No. 2000-367979, even if a user pauses the playback, the pause is forcibly canceled and the playback resumed. In general, the pause function is used when a user wishes, for example, to temporarily stop viewing and leave his or her seat. In other words, there is a problem in that the playback will resume regardless of the fact that the user is not watching, and therefore by the time the user has returned, he/she will have missed the content that have been played back.

By providing a variable-length time-shift buffer, the present invention provides a time-shift playback function in which there is no need to forcefully resume playback when the pausing content being played back.

### SUMMARY OF THE INVENTION

In order to solve the above-mentioned problems with the related art, the present invention provides a recording and reproduction apparatus which includes: a recording buffer in which plural buffer areas used in recording and reproducing content are connected in a linear list; a recording pointer which indicates a position in the recording buffer at which the content is recorded; a reproduction pointer which indicates a position in the recording buffer at which the content is reproduced; a content recording control unit which, in the case where recording of the content has progressed and the recording pointer has passed the end of the last buffer area, creates a new buffer area connected to the end of the so recording buffer in the linear list, and positions the recording pointer at the start of the newly-created buffer; and a content reproduction control unit which, in the case where reproduction of the content has progressed and the reproduction pointer has passed the end of a buffer area, deletes the buffer, and positions the reproduction pointer at the start of the next buffer area connected in the linear list.

In addition, a recording and reproduction apparatus includes: a recording buffer in which plural buffer areas used in recording and reproducing content are connected in a linear list; a recording pointer which indicates a position in the recording buffer at which the content is recorded; a reproduction pointer which indicates a position in the recording buffer at which the content is reproduced; a content recording control unit which, in the case where recording of the content has progressed and the recording pointer has passed the end of the last buffer area, creates a new buffer area connected to the end of the recording buffer in the linear list, and positions the recording pointer at the start of the newly-created buffer; and a content reproduction control unit which, in the case where reproduction of the content has progressed and the reproduction pointer has passed the end of a buffer area, and the content needs to be reproduced for a length of time even if the buffer area is deleted, deletes the buffer, and positions the reproduction pointer at the start of the next buffer area connected in the linear list.

Furthermore, the content recording control unit, in the case where recording of the content has progressed and the recording pointer has passed the end of the last buffer area, and the upper limit of the total number of buffers is not exceeded even if a new buffer area is created, creates a new buffer area connected to the end of the recording buffer in the linear list, and positions the recording pointer at the start of the newly-created buffer.

In addition, the recording and reproduction apparatus according further includes a format conversion recording unit which converts the format of a specified part of the content and records the specified part of the content in association with the buffer area that corresponds to the period in which the specified part of the content was sent; the content is recorded into the recording buffer with the exception of the specified part of the content; and when reproducing, from the recording buffer, the content with the exception of the specified part of the content, the specified part of the content recorded into the format conversion recording unit is reproduced simultaneously in accordance with the time at which the reproduction pointer is positioned.

Further still, the recording and reproduction apparatus further includes a receiving unit which receives a broadcast; and the content is the entirety of an MPEG-2 transport stream received by the receiving unit.

Moreover, the recording and reproduction apparatus further includes a program downloading unit which downloads a program; and a content recording control start unit which starts a process of said content recording control unit based on an instruction from the program.

Lastly, the recording and reproduction apparatus further includes a reproduction speed and position change unit which changes the movement speed and position of the reproduction pointer based on an instruction from the program.

According to claim 1, a buffer area is not deleted until the reproduction of content recorded in that buffer area finishes, even in the case where the reproduction speed is slower than the recording speed; therefore, it is possible to provide a recording and reproduction apparatus that has a time-shift buffer in which the reproduction position is not forcefully changed.

According to claim 2, it is guaranteed that content of the minimum length of time required in the recording buffer will remain; therefore, it is possible to provide a recording and reproduction apparatus that has a time-shift buffer in which the minimum length of time of content to be recorded is set.

According to claim 3, it is possible to provide a recording and reproduction apparatus that has a time-shift buffer that can function within a range that does not exceed a certain amount of space, even in the case where the space in the storage device is limited.

According to claim 4, it is possible to record and reproduce having converted part of the content into a different format; therefore, it is possible to provide a recording and reproduction apparatus that has a time-shift buffer that consumes less space in the storage device.

According to claim 5, it is possible to record the entirety of the MPEG-2 transport stream received from the broadcast wave; therefore, it is possible to provide a recording and reproduction apparatus that has a time-shift buffer in which there is no limit on the service that can be reproduced.

According to claim 6, it is possible to provide a recording and reproduction apparatus that has a time-shift buffer in which time at which a recording buffer is created can be controlled by a downloaded application.

According to claim 7, it is possible to provide a recording and reproduction apparatus that has a time-shift buffer in which a downloaded application can freely control the reproduction speed and reproduction position.

### FURTHER INFORMATION ABOUT TECHNICAL BACKGROUND TO THIS APPLICATION

The disclosure of U.S. patent application No. 60/751,375, filed Dec. 19, 2005, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcast system according to the present invention;

FIG. 2 is an example of how to use a frequency band used in communications between a system on the broadcast system side and a terminal apparatus, in a cable television system according to the present invention;

FIG. 3 is an example of how to use a frequency band used in communications between a system on the broadcast system side and a terminal apparatus, in a cable television system according to the present invention;

FIG. 4 is an example of how to use a frequency band used in communications between a system on the broadcast system side and a terminal apparatus, in a cable television system according to the present invention;

FIG. 5 is a configuration diagram of a TS packet predefined by MPEG-2 specifications;

FIG. 6 is a schematic diagram of an MPEG-2 transport stream;

FIG. 7 is an example of division when a PES packet predefined by MPEG-2 specifications is transmitted using TS packets;

FIG. 8 is an example of division when an MPEG-2 section predefined by MPEG-2 specifications is transmitted using TS packets;

FIG. 9 is a configuration diagram of an MPEG-2 section predefined by MPEG-2 specifications;

FIG. 10 is an example of use of an MPEG-2 section predefined by MPEG-2 specifications;

FIG. 11 is an example of use of a PMT defined by MPEG-2 specifications;

FIG. 12 is an example of use of a PAT defined by MPEG-2 specifications;

FIG. 13 is a configuration example of a hardware configuration of a broadcast recording and reproduction apparatus according to the present invention;

FIG. 14 is an example of a front panel of an input unit 1310 in a hardware configuration of a terminal apparatus 1200 according to the present invention;

FIG. 15 is an example of a device connection at the time of recording, in the recording and reproduction apparatus according to the present invention;

FIG. 16 is an example of a device connection at the time of reproduction, in the recording and reproduction apparatus according to the present invention;

FIG. 17 is a diagram showing a structure of the program stored in a terminal apparatus according to the present invention;

FIG. 18 is a diagram showing a structure of the program stored in a terminal apparatus according to the present invention;

FIG. 19 is an example of an EPG executed by a terminal apparatus according to the present invention;

FIG. 20 is an example of information stored in the secondary storage unit according to the present invention;

FIG. 21 shows a configuration of a time-shift buffer and an example of a buffer area management table according to the present invention;

FIG. 22 is a schematic diagram showing a content of AIT prescribed by the DVB-MHP standard according to the present invention;

FIG. 23 is a schematic diagram showing a file system sent in DSM-CC format according to the present invention;

FIG. 24 is a schematic diagram of a private section management table according to the present invention;

FIG. 25 is an example of a device connection at the time of recording, in the recording and reproduction apparatus according to the present invention;

FIG. 26 is a configuration example of a hardware configuration of a broadcast recording and reproduction apparatus according to the present invention;

FIG. 27 is an example of a device connection at the time of recording, in the recording and reproduction apparatus according to the present invention;

FIG. 28 is an example of a device connection at the time of reproduction, in the recording and reproduction apparatus according to the present invention;

FIG. 29 is an example of an AIT information management table according to the present invention;

FIG. 30 is a flowchart showing time-shift buffer write processing according to the present invention;

FIG. 31 shows a configuration of a time-shift buffer and an example of a buffer area management table according to the present invention;

FIG. 32 shows a configuration of a time-shift buffer and an example of a buffer area management table according to the present invention;

FIG. 33 shows a configuration of a time-shift buffer and an example of a buffer area management table according to the present invention;

FIG. 34 is a flowchart showing time-shift buffer write processing according to the present invention;

FIG. 35 shows a configuration of a time-shift buffer and an example of a buffer area management table according to the present invention; and

FIG. 36 is an example of a file management system according to the present invention.

### DESCRIPTION OF THE PREFERRED EMBODIMENTS

### First Embodiment

Hereafter, an apparatus and a method according to the first embodiment of the present invention shall be described with reference to the drawings. The present invention is aimed at recording and reproduction of sent and received content with an arbitrary medium; however, in the present embodiment, a cable television broadcast system shall be described as an example. In the cable television broadcast system, the broadcast recording and receiving apparatus is generally called a terminal apparatus.

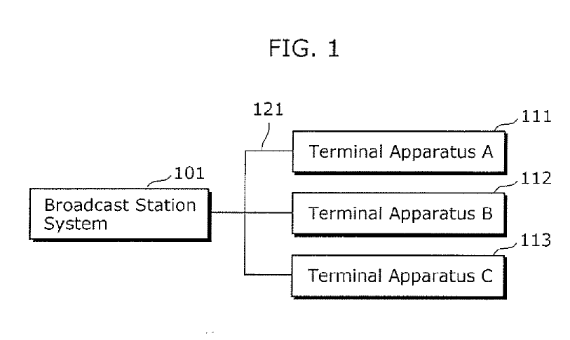

FIG. 1 is a block diagram showing a relationship of apparatuses that make up a broadcast system; the broadcast system is made up of a broadcast station system 101, and three terminal apparatuses, or a terminal apparatus A111, a terminal apparatus B112, and a terminal apparatus C113. A coupling 121 between the broadcast station system and each terminal apparatus is, in the cable system, a wired coupling such as a coaxial cable, a fiber-optic cable, and the like. In FIG. 1, one broadcast station system is coupled with three terminal apparatuses, but there may be any number of terminal apparatuses.

The broadcasting station system 101 sends information such as video/audio/data for data broadcasting in a broadcast signal to a plurality of terminal apparatuses. The broadcast signal is sent using a frequency within a frequency band set by an operational default of the broadcasting system, the laws of a region/country in which the broadcasting system is operated, and so on.

With the cable system in the present embodiment, the frequency band used in broadcast signal transmission is divided for each data content and transmission direction (inbound, outbound) and assigned thereto.

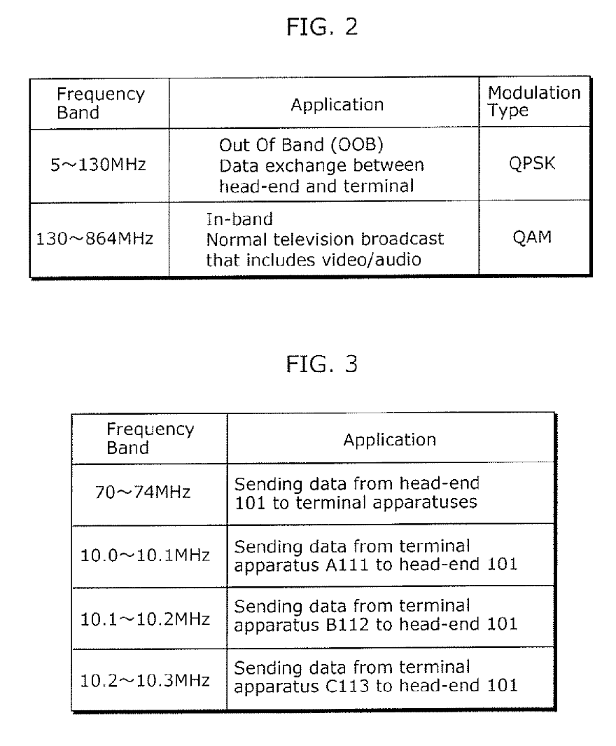

FIG. 2 is a table showing one example of the division of the frequency bands. The frequency bands can be roughly divided into two types: Out Of Band (abbr. OOB) and In-Band. 5 MHz to 130 MHz is assigned as OOB, and is mainly used in data exchange between the broadcast station system 110 and the terminal apparatuses A111, B112, and C113. 130 MHz to 864 MHz is assigned as In-Band, and is mainly used in an outbound-only broadcast channel that includes video/audio. OOB uses the QPSK modulation type, and In-Band uses the QAM64 or QAM256 modulation type. Modulation type technology is generally known and of little concern to the present invention, and therefore detailed descriptions shall be omitted.

FIG. 3 is one example of a more detailed use of the OOB frequency band. 70 MHz to 74 MHz is used in outbound data sending from the broadcast station system 101, and all of the terminal apparatuses A111, B112, and C113 receive the same data from the broadcast station system 101. On the other hand, 10.0 MHz to 10.1 MHz is used in inbound data sending from the terminal apparatus A111 to the broadcast station system 101; 10.1 MHz to 10.2 MHz is used in inbound data sending from the terminal apparatus B112 to the broadcast station system 101; and 10.2 MHz to 10.3 MHz is used in inbound data sending from the terminal apparatus C113 to the broadcast station system 101. Through this, it is possible to independently send data unique to each terminal apparatus from each terminal apparatus A111, B112, and C113 to the broadcast station system 101.

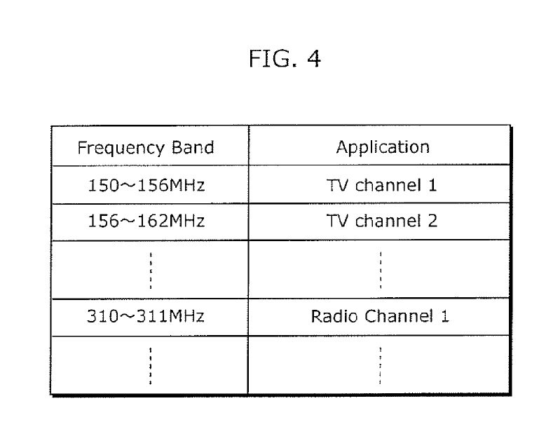

FIG. 4 is one example of use of an In-Band frequency band. 150 MHz to 156 MHz and 156 MHz to 162 MHz are assigned to a TV channel 1 and a TV channel 2 respectively; TV channels are assigned in 6 MHz intervals thereafter. Radio channels are assigned in 1 MHz units from 310 MHz on. Each of these channels may be used as analog broadcast or as digital broadcast. Digital broadcast is sent in TS packet format based on the MPEG-2 specifications, and it is also possible to send data for each kind of data broadcast, TV show organization information for configuring EPG, and so on, in addition to audio and video.

The broadcast station system 101 uses the frequency bands described above to send an appropriate broadcast signal to the terminal apparatuses, and therefore has a QPSK modulation unit, a QAM modulation unit, and so on. In addition, the broadcast station system 101 has a QPSK demodulator for receiving data from the terminal apparatuses. Moreover, the broadcast station system 101 can be thought of as having various devices related to the modulation unit and the demodulation unit. However, the present invention relates mainly to the terminal apparatuses, and therefore detailed descriptions shall be omitted.

On the other hand, the terminal apparatuses A111, B112, and C113 each have a QAM demodulation unit and a QPSK demodulation unit in order to receive and reproduce a broadcast signal from the broadcast station system 101. In addition, each terminal apparatus has a QSPK modulation unit in order to send its unique data to the broadcast station system side 101. In the present invention, the terminal apparatuses are broadcast recording and reproduction apparatuses, and detailed configurations shall be described later.

The broadcasting station system 101 modulates an MPEG-2 transport stream and transmits the stream within the broadcast signal. A broadcast receiving apparatus receives the broadcast signal, demodulates and reproduces the MPEG-2 transport stream, and from the stream, extracts and uses necessary information. In order to describe a device function and connection structure present in the terminal apparatus, the structure of the MPEG-2 transport stream is first described in a simple manner.

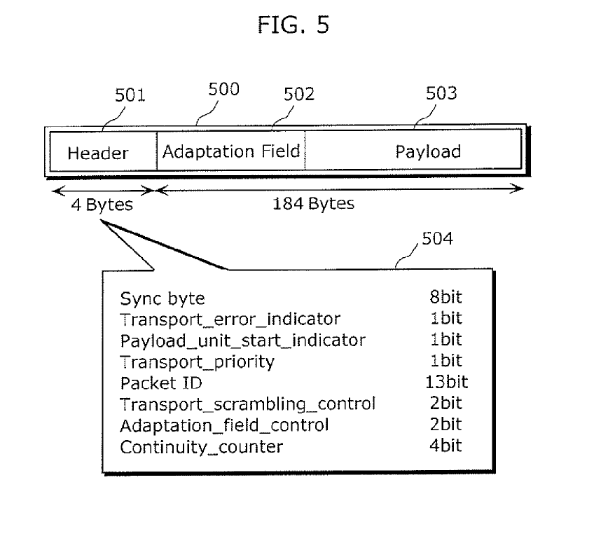

FIG. 5 is a diagram showing the structure of a TS packet. A TS packet 500 has a length of 188 bytes, and is composed of a header 501, an adaptation field 502, and a payload 503. The header 501 holds control information of the TS packet. The header has a length of 4 bytes, and has the structure shown in 504. In the header 501 there is a field denoted as “Packet ID” (hereafter, PID), and the TS packet is identified through the value of this PID. The adaptation field 502 holds additional information such as time information. The adaptation field S02 is not mandatory, and there are cases where there is no adaptation field 502. The payload 503 holds information transmitted by the TS packet, such as video, audio, and data used in data broadcast.

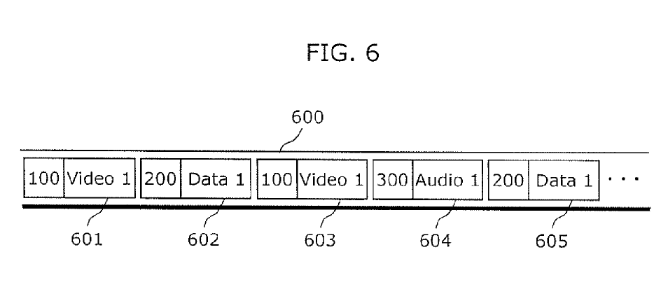

FIG. 6 is a schematic diagram of an MPEG-2 transport stream. The TS packet holds various information in the payload, such as video, audio, data used for data broadcast, and the like. A TS packet 601 and a TS packet 603 hold a PID of 100 in the header, and hold information regarding video 1 in the payload. A TS packet 602 and a TS packet 605 hold a PID of 200 in the header, and hold information regarding data 1 in the payload. A TS packet 604 holds a PID of 300 in the header, and holds information regarding audio 1 in the payload. Mixing TS packets which hold various types of data in the payloads and transmitting these as a series in sequence is called multiplexing. An MPEG-2 transport stream 600 is one example of a configuration in which the TS packets 601 to 605 are multiplexed.

TS packets that have identical PIDs hold identical types of information. Therefore, the terminal apparatus reproduces video and audio, and reproduces data such as TV show organization information, by receiving multiplexed TS packets and extracting, per PID, the information that the TS packet holds. In FIG. 6, the TS packet 601 and the TS packet 603 each transmit information regarding the video 1, and the TS packet 602 and the TS packet 605 each transmit information regarding the data 1.

Here, descriptions shall be given regarding a format of each type of data contained in the payload.

Video and audio are expressed by a format called a Packetized Elementary Stream (PES) packet. The PES packet includes video information or audio information of a certain time period, and by receiving the PES packet, the broadcast recording and reproduction apparatus can output the video and audio information contained in that PES packet to a display and a speaker. The broadcast station transmits the PES packets without pause, and therefore it is possible for the broadcast recording and reproduction apparatus to continuously reproduce the video and audio without pause. When the PES packet is actually transmitted, it is divided and stored in the payloads of a plurality of TS packets in the case where the PES packet has a size larger than that of the payload of one TS packet.

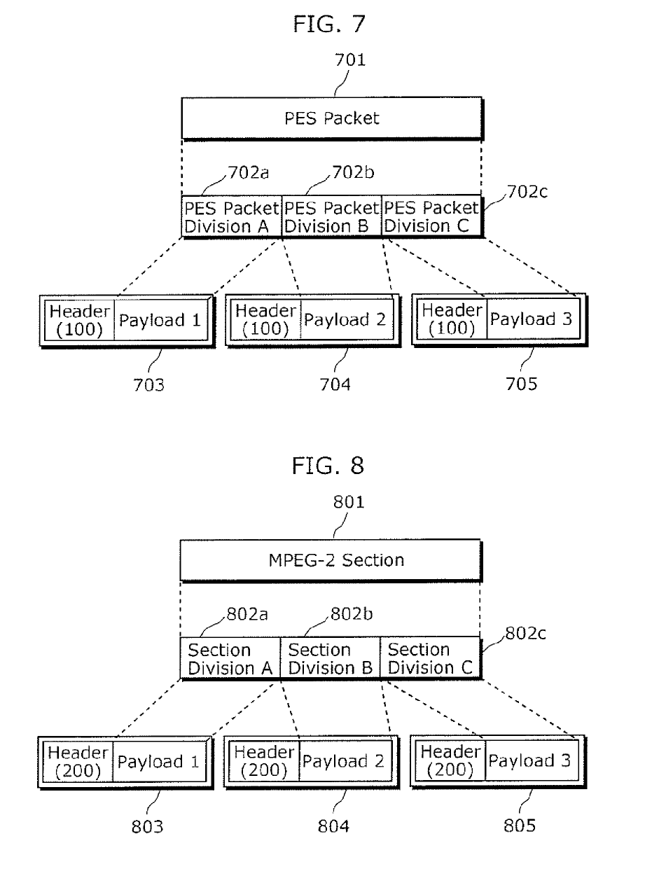

FIG. 7 shows an example of division when a PES packet is transmitted. A PES packet 701 is too large to be stored and transmitted in a payload of a single TS packet, and therefore the PES packet 701 is divided into a PES packet division A 702a, a PES packet division B 702b, and a PES packet division C 702c, and is transmitted by three TS packets 703 to 705 which have identical PIDs. In actuality, the video and audio is obtained as an elementary stream (ES) that is obtained by concatenating data contained in the payloads of a plurality of PES packets. The format of this elementary stream is digitalized video and audio, such as defined by the MPEG-2 Video standard, the MPEG-1 and 2 Audio standards, and the like.

On the other hand, information such as the TV show organization information and data used for data broadcast is expressed using a format called “MPEG-2 section.” When the MPEG-2 section is actually transmitted, the MPEG-2 section is divided and stored in the payloads of a plurality of TS packets in the case where the MPEG-2 section has a size larger than the payload of one TS packet.

FIG. 8 shows an example of division when the MPEG-2 section is transmitted. As an MPEG-2 section 801 is too large to be stored and transmitted in a payload of a single TS packet, the MPEG-2 section 801 is divided into a section division A 802a, a section division B 802h, and a section division C 802c, and is transmitted by three TS packets 803 to 805 which have identical PIDs.

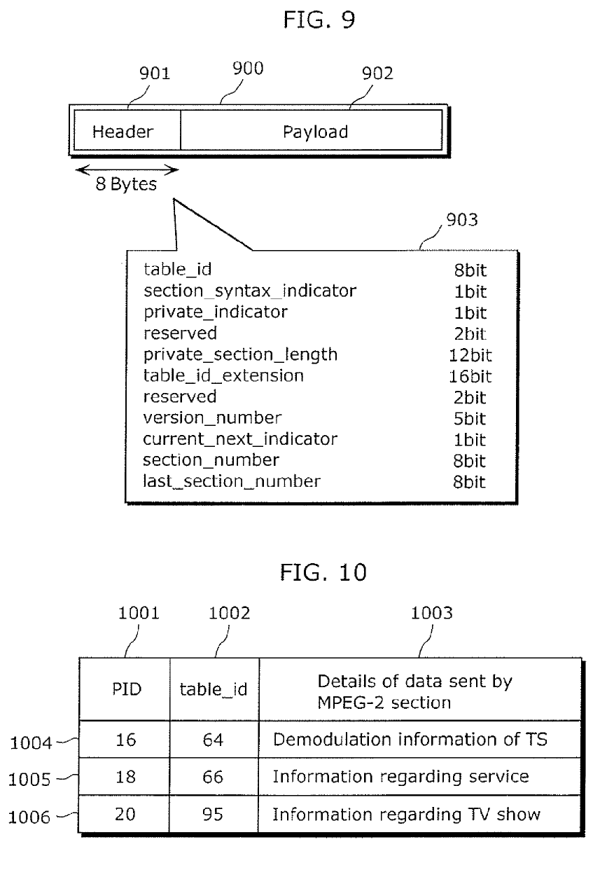

FIG. 9 expresses the structure of the MPEG-2 section. An MPEG-2 section 900 is configured of a header 901 and a payload 902. The header 901 holds control information of the MPEG-2 section. That structure is expressed by a header structure 903. The payload 902 holds data transmitted by the MPEG-2 section 900. A table_id present in the header structure 903 expresses the type of the MPEG-2 section, and a table_id_extension is an extension identifier used when further distinguishing between MPEG-2 sections with identical table_ids.

The case where the TV program lineup information is transmitted, as in FIG. 10, can be given as an example of use of the MPEG-2 section. In this example, as written in row 1004, information necessary for demodulating the broadcast signal is denoted in the MPEG-2 section which has a table_id of 64 in the header structure 903; furthermore, this MPEG-2 section is carried by a TS packet with a PID of 16.

The PES format does not exist in the MPEG-2 section. For that reason, the elementary stream (ES) is what links the payloads of TS packets identified by identical PIDs within the MPEG-2 transport stream. For example, in FIG. 8, the TS packets 803 to 805, in which the MPEG-2 section 801 is divided and transmitted, all are identified with the PID of 200. It can be said that this is an ES which carries the MPEG-2 section 801.

A concept called a program further exists in MPEG-2 transport stream. The program is expressed as a collection of ESs, and is used when handling a plurality of ESs all together. When the program is used, it is possible to handle video/audio, as well as accompanying data broadcast data, all together. For example, in the case of simultaneously handling the video/audio to be reproduced, by grouping the video ES and the audio ES as a program, the broadcast recording and reproduction apparatus should simultaneously reproduce these two ESs as one TV show.

To express the program, two tables, called a Program Map Table (PMT) and a Program Association Table (PAT) are used in MPEG-2. Detailed descriptions can be found in the ISO/IEC 13818-1 “MPEG-2 Systems” specification. The PMT and the PAT shall be described hereafter in simple terms.

The PMT is a table included in the MPEG-2 transport stream, the number of which is equivalent to the number of programs. The PMT is configured as an MPEG-2 section, and has a table_id of 2. The PMT holds a program number used in identifying the program and additional information of the program, as well as information regarding an ES belonging to the program.

An example of the PMT is given in FIG. 11. 1100 is a program number. The program numbers are assigned uniquely to programs in the same transport stream, and are used in identifying the PMTs. Rows 1111 to 1114 express information regarding individual ESs. A column 1101 is a type of ES, in which “video,” “audio,” “data,” and so on are specified. Column 1102 is the PIDs of the TS packets that make up the ES. Column 1103 is additional information regarding the ES. For example, the ES shown in the row 1111 is an audio ES, and is transmitted by TS packets with a PID of 5011.

The PAT is a table present in the MPEG-2 transport stream, of which there is only one. The PAT is configured as an MPEG-2 section, has a table_id of 0, and is transmitted by a TS packet with a PID of 0. The PAT holds a transport_stream_id used in identification of the MPEG-2 transport stream, and information regarding all PMTs that represent a program existing in the MPEG-2 transport stream.

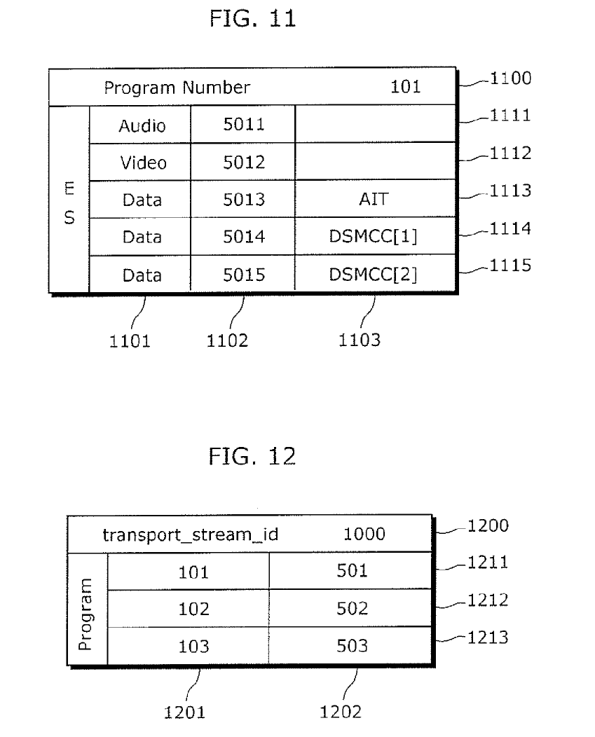

An example of the PAT is given in FIG. 12. 1200 is a transport_stream_id. The transport_stream_id is used in identifying the MPEG-2 transport stream. Rows 1211 to 1213 express information regarding the program. Column 1201 is the program number. Column 1202 is the PID of the TS packet which carries the PMT corresponding to the program, For example, the PMT of the program shown in row 1211 has a program number of 101, and the corresponding PMT is carried by the TS packet with a PID of 501.

In the case where the terminal apparatus reproduces a certain program, the terminal apparatus uses the PAT and the PMT and specifies the video and audio that make up a program, and reproduces that video and audio. For example, with the MPEG-2 transport stream that transmits the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from a TS packet with a PID of “0”. The PAT is searched for a program with the program number “101”, and the row 1211 is obtained. From row 1211, the PID “501”, of the TS packet which carries the PMT of the program with a program number “101”, is obtained. Next, the PMT transmitted as the MPEG-2 section with a table_id of “2” is acquired from the TS packet with the PID of “501”. A row 1111, which is audio ES information, and a row 1112, which is video ES information, are obtained from the PMT. A PID “5011” of the TS packet which transmits the audio ES is obtained from the row 1111. In addition, a PID “5012” of the TS packet which transmits the audio ES is obtained from the row 1112. Next, an audio PES packet is acquired from the TS packet with a PID “5011”, and a video PES packet is acquired from the TS packet with a PID of “5012”. Through this, it is possible to isolate the video and audio PES packets to be reproduced, and the video and audio transmitted by these packets can be reproduced.

Note that there are cases where the MPEG-2 transport stream is scrambled. This is a setup called limited viewing. For example, by scrambling the PES packets which transmit a certain video and audio, only specified viewers who can descramble the PES packets are able to view that video and audio. In order to descramble and view the video and audio, a viewer must descramble the video and audio using a device called a descrambler. For example, in an OCAP-compatible terminal apparatus, a card-form adapter with an internal descrambler is used. A cable television operator distributes an adapter set to be able to decode a specified program to each viewer, and the viewer inserts that adapter into the terminal apparatus. Upon doing so, the adapter descrambles the specified program based on descrambling information such as a descrambling key and contract information of each contract holder. The method of descrambling, the method of obtaining the descrambling key, and the like depend on the adapter, and have no influence on the implementation of the present invention.

Thus far, simple descriptions have been given regarding MPEG-2 specifications, and hereafter, detailed definitions of terms shall be given. In the present invention, there are two types of the term “program.” One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program.” Furthermore, concerning the latter, a “program” particularly written in the Java™ language is called a “Java program.”

Description has been given regarding several kinds of general information specified in the MPEG-2 specifications according to the present invention. Hereafter, the broadcast recording and reproduction terminal used in the present embodiment is described in detail.

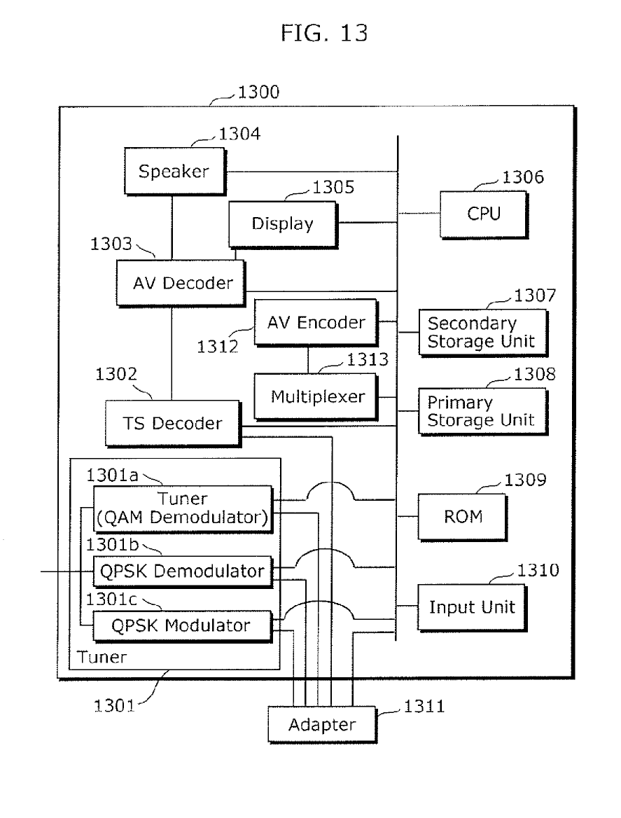

FIG. 13 is a block diagram showing a general hardware a configuration of the broadcast recording and reproduction apparatus according to the present embodiment, or a specific internal configuration of the terminal apparatuses 111, 112, and 113 shown in FIG. 1. 1300 is the broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROMS 1309; an input unit 1310; an adapter 1311; an AV encoder 1312; and a multiplexer (MPEG-2 Transport Stream Multiplexer or the like) 1313. Note that the present embodiment is implemented by expanding a broadcast recording and reproduction terminal realized by the OCAP-DVR specifications, and the basic hardware configuration is nearly identical to that required by the OCAP-DVR specifications.

The tuner 1301 is a device which demodulates a broadcast signal modulated and transmitted from the broadcast station system 101, in accordance with tuning information including a frequency prescribed by the CPU 1306. The tuner 1301 includes: a QAM demodulator 1301a that internally demodulates an In-band signal; a QPSK demodulator 1301b that demodulates an Out-of-band signal; and a QPSK modulator 1301c that performs modulation, An MPEG-2 transport stream obtained as a result when the QAM demodulator 1301a of the tuner 1301 demodulates the In-band signal passes through the adapter that has a descrambling function, and is sent to the TS decoder 1302.

The TS decoder 1302 is a device which has a function to segregate PES packets and MPEG-2 sections which comply with specified conditions from the MPEG-2 transport stream, based on a PID, a section filter condition, and so on prescribed by the CPU 1306. This segregation function is called packet filtering. Two types of filter devices, which are a PID filter and a section filter, are included within the TS decoder. Details on filtering are given later. Input of the MPEG-2 transport stream to the TS decoder is performed by plural types of constituent elements. In the case where a broadcast is received and a service is reproduced without recording, the MPEG-2 transport stream which the adapter 1311 outputs is inputted to the TS decoder 1302. On the other hand, in the case of reproducing a service recorded in the secondary storage unit 1307, the MPEG-2 transport stream which the secondary storage unit 1307 outputs is inputted to the TS decoder 1302. Which input to receive is controlled by the CPU 1306, which receives an instruction from software.

The PES packets of the video and audio which the TS decoder 1302 segregated are outputted to the AV decoder 1303. In addition, the MPEG-2 section segregated by the TS decoder 1302 is transmitted to the primary storage unit 1308 through Direct Memory Access (DMA), and is used by a program and the like executed by the CPU 1306.

The AV decoder 1303 is a device with a function to decode the encoded video ES and audio ES. The AV decoder fetches the ES from the PES packet that transmits the audio and video information transferred from the TS decoder, and decodes the ES. An audio signal and a video signal obtained through the decoding performed by the AV decoder 1303 are outputted to the speaker 1304 and the display 1305 at the time of service reproduction, but are outputted to the AV encoder 1312 at the time of service recording. Which output route to take is controlled by the CPU 1306, which receives an instruction from software.

The speaker 1304 reproduces audio outputted from the AV decoder 1303.

The display 1305 reproduces video outputted from the AV decoder 1303.

The CPU 1306 executes a program that operates in the broadcast recording and reproduction apparatus. The CPU 1306 executes a program contained in the ROM 1309. Or, the CPU 1306 executes a program downloaded from a broadcast signal or a network and held in the primary storage unit 1308. Or, the CPU executes a program downloaded from a broadcast signal or a network and held in the secondary storage unit 1308. The tuner 1301, TS decoder 1302, AV decoder 1303, speaker 1304, display 1305, secondary storage unit 1307, primary storage unit 1308, ROM 1309, and input unit 1310 are controlled in accordance with the directions of the executed program. In addition, the CPU 1306 is not only a device present within the terminal apparatus 1300, but may also communicate with the devices within the adapter 1311 and control the adapter 1311.

The secondary storage unit 1307 is a memory apparatus, the memory of which is not deleted even if the power supply to the device is interrupted; for example, a nonvolatile memory such as a FLASH-ROM, a Hard Disk Drive (HDD), a rewritable media such as a CD-R or a DVD-R, or the like. The secondary storage unit 1307 saves information based on an instruction from the CPU 1306.

The primary storage unit 1308 is a device which has a function for temporarily saving information in accordance with an instruction from the CPU 1306, a DMA-transferable device, and so on, and is configured of a RAM or the like.

The ROM 1309 is an unrewriteable memory device, and to be more specific, is configured of a ROM, a CD-ROM, a DVD, or the like. The program which the CPU 1306 executes is stored in the ROM 1309.

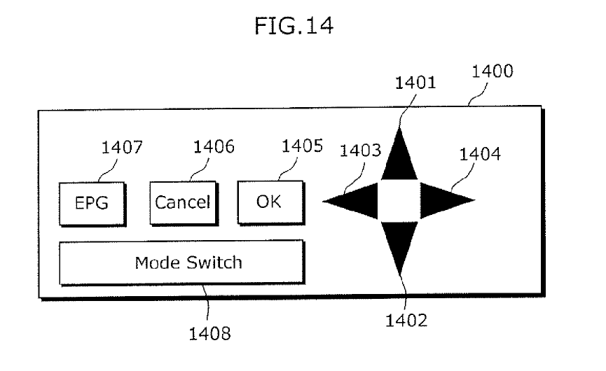

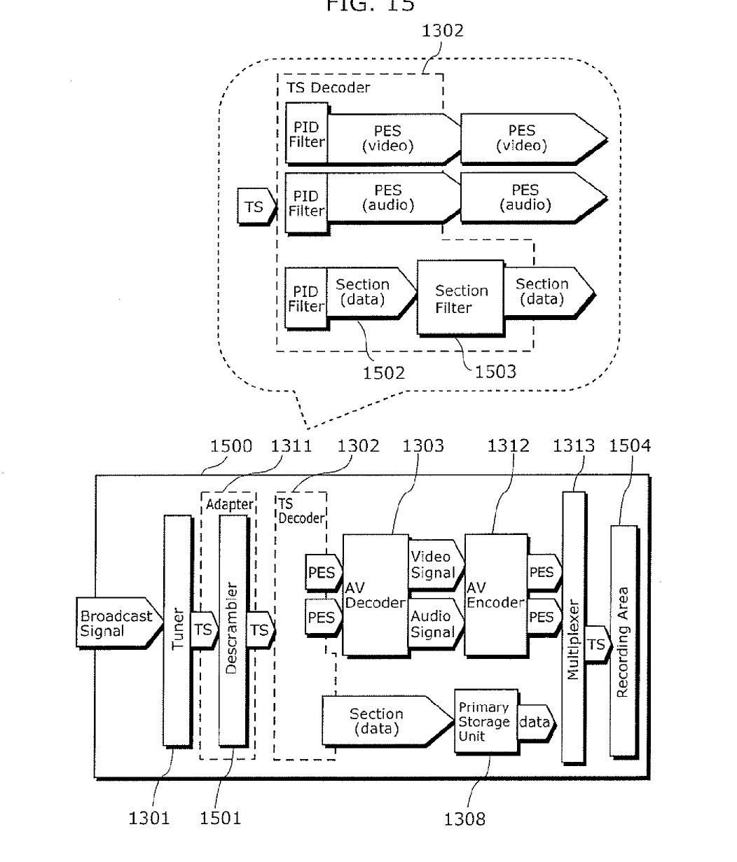

The input unit 1310 is, to be more specific, configured of a front panel or a remote control receiver, and accepts an input from the user, FIG. 14 is one example of a case where the input unit 1310 is configured of the front panel. A front panel 1400 has seven buttons: an up cursor button 1401, a down cursor button 1402, a left cursor button 1403, a right cursor button 1404, an OK button 1405, a cancel button 1406, an EPS button 1407, and a mode switch button 1408. When the user presses a button, an identifier of the pressed button is notified to the CPU 1306.

The adapter 1311 is a device for descrambling the MPEG-2 transport stream sent in the In-hand frequency range, and includes one or more descramblers. The MPEG-2 transport stream outputted by the tuner 1301a is inputted into the adapter 1311, and the TS packet that has the PID specified by the CPU 1306 is descrambled. The adapter 1311 outputs the descrambled MPEG-2 transport stream to the TS decoder 1302.

Furthermore, the adapter 1311 also carries out format conversion of data sent in an OOB frequency range. The information transmitted OOB is QPSK-modulated. Regarding outbound transmission, the QPSK demodulator 1301b demodulates the outbound signal sent from the broadcast station system 101, and inputs a generated hit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, regarding inbound transmission, the CPU 1306 inputs information to be sent to the broadcast station system 101, into the adapter 1311. The adapter 1311 converts the information inputted from the CPU 1306 to a format that can be interpreted by the broadcast station system 101, and inputs this to the QPSK modulator 1301c. The QPSK modulator 1301c QPSK-modulates the information inputted from the adapter 1311, and sends this to the broadcast station system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313. The AV encoder 1312 can be realized by publicly-known technology.

The multiplexer 1313 is a device which has a function to multiplex, into an MPEG-2 transport stream, video and audio inputted from the AV encoder 1312 as well as private section data filtered and separated by the TS decoder. The multiplexer 1313 can be realized by publicly-known technology.

A process in which the broadcast recording and reproduction apparatus described above records a service contained in a broadcast wave into the secondary storage unit 1307, and a process where the broadcast recording and reproduction apparatus consecutively reads out the service from the secondary storage unit 1307 and reproduces it, shall be described in detail hereafter.

First, the process in which the service contained in the broadcast wave is recorded into the secondary storage unit 1307 is described.

FIG. 15 shows a conceptual diagram which represents the physical connection sequence, processing details, and input/output data format of each device during recording of the service. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504, Constituent elements in FIG. 15 that have the same reference numbers as in FIG. 13 have the same functions and thus description is omitted.

First, the tuner 1301 performs tuning on the broadcast wave in accordance with a tuning instruction provided by the CPU 1306. The tuner 1301 demodulates the broadcast wave and inputs the MPEG-2 transport stream into the adapter 1311.

The descrambler 1501, which is within the adapter 1311, descrambles the MPEG-2 transport stream based on limitation removal information for each viewer. The descrambled MPEG-2 transport stream is inputted into the TS decoder.

Two types of devices that process the MPEG-2 transport stream are present within the TS decoder 1302: the PID filter 1502 and the section filter 1503.

The PID filter 1502 extracts, from the inputted MPEG-2 transport stream, a TS packet that has a PID specified by the CPU 11306, and then extracts a PES packet and an MPEG-2 section present in that payload, For example, when the MPEG-2 transport stream in FIG. 6 is inputted in the case where the CPU 1306 has instructed PID filtering, which extracts the TS packet with a PID of 100, packets 601 and 603 are extracted, then concatenated, and thus a PES packet of the video 1 is reconfigured. Or, when the MPEG-2 transport stream in FIG. 6 is inputted in the case where the CPU 1306 has instructed PID filtering, which extracts the TS packet with a PID of 200, packets 602 and 605 are extracted, then concatenated, and thus an MPEG-2 section the data t is reconfigured.

The section filter 1503 extracts the MPEG-2 section which conforms to a section filter condition specified by the CPU 1306 from among the inputted MPEG-2 sections, and DMA-transfers this MPEG-2 section to the primary storage unit 1308. A PID value can be specified as the section filter condition, and a table_id value can be specified as an auxiliary condition. For example, it is assumed that the CPU 1306 specifies, for the section filter 1503, PID filtering which extracts the TS packet with a PID of 200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308, which is a buffer.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet so as to convert it into the video, and inputs this into the AV encoder 1312. The AV decoder also decodes the audio PES packet so as to convert it into the audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted form the AV encoder onto the MPEG-2 section inputted from the primary storage unit 1308, and thus generates an MPEG-2 transport stream. The generated MPEG-2 transport stream is recorded into the recording area 1504.

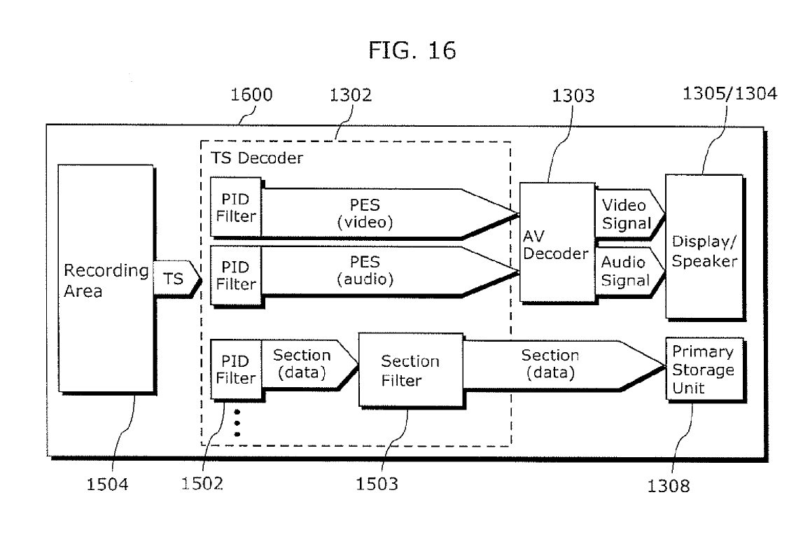

The recording area 1504 is made up of all or a part of the secondary storage unit 1307, or another recording area, and records the MPEG-2 transport stream that makes up a service. In the present invention, the recording area 1504 is configured as a time-shift buffer, the details of which shall be described later. Recording of the MPEG-2 transport stream that makes up the service illustrated in FIG. 15 into the secondary storage unit 1307 (in other words, service recording) and sequential readout from the secondary storage unit 1307 (in other words, service reproduction), which shall be described later using FIG. 16r can be performed simultaneously.

Next, a process in which the service is consecutively read out from the secondary storage unit 1307 and reproduced shall be described.

FIG. 16 is a conceptual diagram which represents the physical connection sequence, processing details, and input/output data format of each device during recording of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same reference numbers as in FIG. 13 have the same functions, and thus descriptions shall be omitted.

The MPEG-2 transport stream recorded in the recording area 1504 in the procedure illustrated in FIG. 15 is inputted into the TS decoder 1302.

Then, a video PES and an audio PES that have a PID specified by the CPU 1306 are extracted by the PID filter 1502 within the TS decoder 1302. The extracted PES packets are inputted into the AV decoder 1303. Or, the MPEG-2 section that has a PIP and a table_id specified by the CPU 1306 is extracted by the PID filter 1502 and the section filter 1503 within the TS decoder 1302. The extracted MPEG-2 section is DMA-transferred to the primary storage unit 1308.

The video PES and the audio PES inputted into the AV decoder 1303 are decoded and outputted as an audio signal and a video signal. After that, the audio signal and the video signal are inputted into the display 1305 and the speaker 1304, thus reproducing the audio and the video.

The MPEG-2 section inputted into the primary storage unit 1308 is inputted into the CPU 1306 and used by software when appropriate.

Thus far, an example of the hardware configuration of the present invention has been described; hereafter, an example of the software configuration of the present invention shall be given. Recording of the service in the present invention refers to recording video, audio, a Java program, synchronization information of the Java program, and so on that are contained in the service, into an arbitrary storage medium such as a hard disk, a Blu-ray Disc (BD), a Digital Versatile Disc (DVD), or a Secure Digital (SD) memory card. These storage media are, in the configuration diagram shown in FIG. 13, denoted as the secondary storage unit 1307. Reproduction of the service refers to execution and reproduction based on the video, audio, Java program, and synchronization information of the Java program recorded in the recording medium. A reproduction result of a recorded service is required to be almost equivalent to a result of directly reproducing the service upon receiving a broadcast wave.

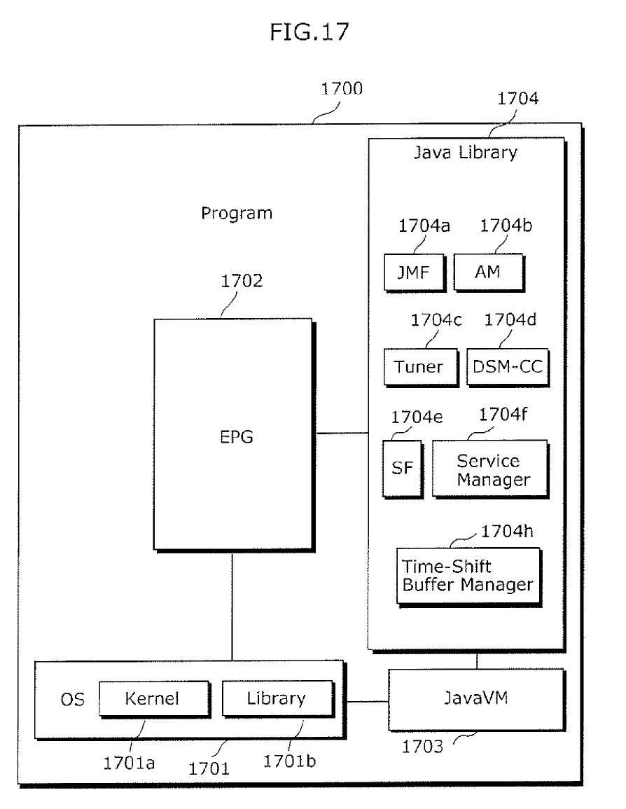

FIG. 17 is a configuration diagram of a program necessary for recording and reproduction of the service, and is software recorded into the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of a kernel 1701a for executing other sub-programs such as the EPG 1702 and the lava VM 1703, and a library 1701b which the sub-programs use to control the constituent elements of the terminal apparatus 1300, The kernel 1701a is publicly-known technology and therefore detailed descriptions shall be omitted.

The library 1701b provides, for example, a tuning function for controlling the tuner. The library 1701b accepts, from another sub-program, tuning information that includes a frequency, and supplies this to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

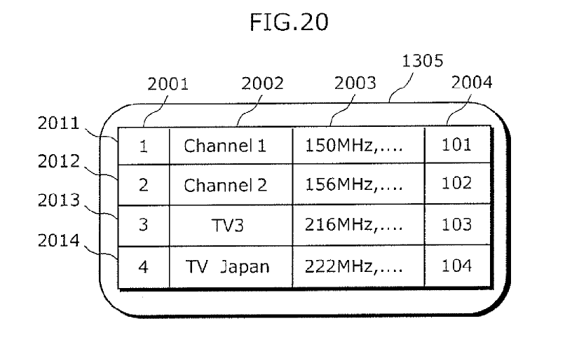

Also, the library 1701b provides channel information for uniquely identifying a channel. An example of the channel information is shown in FIG. 20. The channel information is sent using an OOB or an In-band frequency range, is converted into a chart format by the adapter 1311, and is stored in a temporary memory unit accessible by the library. A column 2001 is a channel identifier, and is equivalent to, for example, a source_ID as defined by SCTE65 Service Information Delivered Out-Of-Band For Digital Cable Television. A column 2002 is a channel name, and is equivalent to a source_name, from the same SCTE65 standard. A column 2003 is tuning information, and is information such as a frequency, a transfer rate, a modulation formation, and the like that is given to the tuner 1301. A column 2004 is a program number for specifying the PMT. For example, a row 2011 is a group of service information including a channel identifier of “1”, a channel name of “channel 1”, a frequency of “150 MHz . . . ” in the tuning information, and a program number of “101”.

In addition to this, it is also possible for the library 1701b to set parameters used in control of the hardware constituent elements shown in FIG. 13. Individual functions shall be described later.

The JavaVM 1703 is a Java virtual machine that sequentially analyzes and executes programs written in the Java™ language. Programs written in the Java language are compiled of intermediate code which does not depend on the hardware, called bytecode. The Java Virtual Machine is an interpreter which executes this bytecode. The Java VM 1703 executes the Java library 1704 that is written in the Java language. Details of the Java language and Java VM are explained in publications such as “Java Language Specification” (ISBN 0-201-63451-1) and “Java Virtual Machine Specification” (ISBN 0-201-63451-X), and so on. In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by the Java program in order to control functions of the broadcast recording and reproduction apparatus. However, there are situations where a sub-program written in non-Java language, such as the library 1701b of the OS 1701, is used as necessary. The Java program can use a function provided by the Java library 1740 by calling a Java Application Programming Interface (API) held by the Java library 1704.

A tuner 1704c is a Java library for controlling the In-band receiving tuner 1301a in the broadcast recording and reproduction terminal. When the Java program passes tuning information including a frequency to the tuner 1704c, the tuner 1704 uses that information to invoke a tuning function of the library 1701b, and as a result, it is possible to control an operation of the In-band receiving tuner 1301a of the broadcast recording and reproduction terminal.

An SF 1704e is a Java library for controlling a function of the PID filter 1502 and the section filter 1503 of the broadcast recording and reproduction terminal. When the Java program passes filtering conditions such as a PID, table_id, and the like to the SF 1704e, the SF 1704e uses a function of the library 1701b based on those conditions, sets the filtering conditions in and controls the PID filter 1502 and the section filter 1503, acquires an MPEG-2 section that fulfills desirable filter conditions, and passes the MPEG-2 section to the Java program that set the filter conditions.

A DSM-CC 1704d is a Java library for accessing a file system of a DSM-CC object carousel. The DSN-CC object carousel is included in the MPEG-2 section acquired by the SF 1704e. The DSM-CC is defined by the ISO/IEC 13818-6 standard, and is a mechanism for using the MPEG-2 section so as to transmit an arbitrary file. By using this, it is possible to send a file from a broadcast station to a terminal. Based on a DSM-CC identifier and a file identifier specified by the Java program and so on, the DSM-CC 1704d uses the SF 1704e and acquires the MPEG-2 section, fetches a file based on the ISO/IEC 13818-6 standard, and outputs this file to the primary storage unit 1308, the secondary storage unit 1307, and the like. A detailed method for implementing the DSM-CC is of no relation to the present invention, and therefore details are omitted.

An AM 1704b is an Application Manager that provides a function for managing the execution and termination of the Java programs contained in the service. The AM 1704b extracts a Java program multiplexed onto a specified channel of a specified MPEG-2 transport stream, and causes the execution or termination of that extracted Java program in accordance with separately-multiplexed synchronization information. A Java class file of the Java program is multiplexed into the MPEG-2 transport stream in the aforementioned DSM-CC format. In addition, the synchronization information of the Java program is in a format called AIT, and is multiplexed into the MPEG-2 transport stream. AIT is an acronym of Application Information Table, as defined in Section 10 of the DVB-MHP specification (ETSITS 101812 DVB-MHP specification V1.0.2, and is an MPEG-2 section with a table_id of “0x74.” In the descriptions of the present embodiment, the AIT used is a modified version of that which is defined by the DVB-MHP specifications.

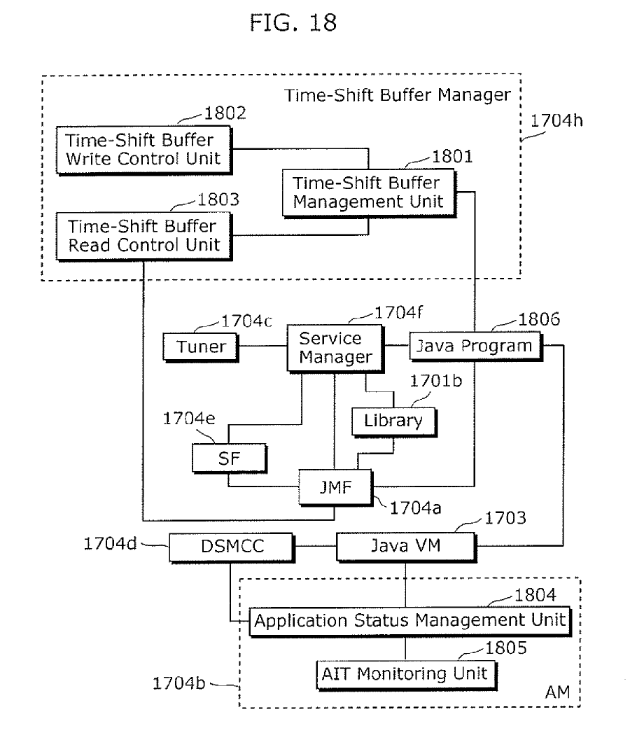

An internal configuration of the AM 1704b is shown in FIG. 18. The AM 1704b is configured of an AIT monitoring unit 1805 and an application status management unit 1804.

In the case where the service is reproduced from the recording area 1504 using the configuration shown in FIG. 16, the AIT monitoring unit 1805 takes, as an input, the private section and channel identifier within the MPEG-2 transport stream outputted by the section filter 1503 of the TS decoder 1302, and monitors the 6 update status of the AIT. First, the AIT monitoring unit 1805 searches channel information in the library 1701b with a specified channel identifier as a key, and obtains the program number of the corresponding service. Next, using the SF 1704e and the like, a PAT is acquired from the MPEG-2 transport stream. Then, the PID of the PMT that corresponds to the obtained program number is obtained from the information of the PIT. Once again, using the SF 1704e, the actual PMT is acquired. The acquired PIT is in a format as shown in FIG. 11, and has written the PID of an elementary stream that has “data” as a stream type and “AIT” as supplemental information. Furthermore, when the PID and table_ID “0x74” of the AIT now obtained as the filtering conditions are given to the SF 1711e, the actual AIT is obtained.

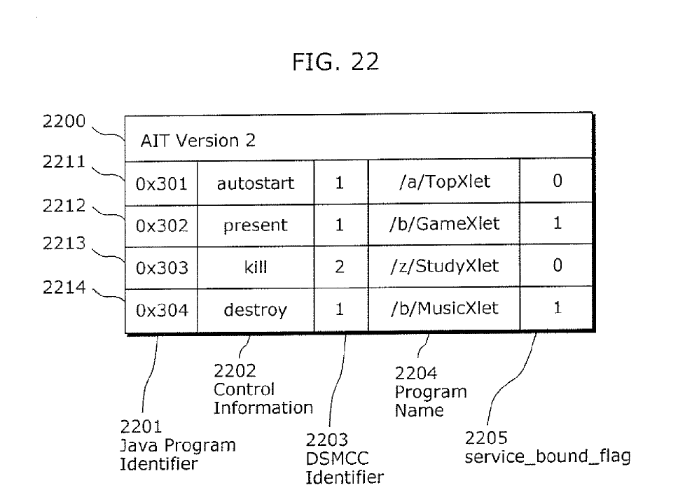

FIG. 22 is a chart that schematically shows an example of the AIT information. An AIT version number 2200 expresses the version of that AIT. The higher the version of the AIT, the newer the AIT is. AIT of the same AIT version are repeatedly received, but the AIT monitoring unit 2402 ignores and does not acquire AIT with the same AIT version as an AIT that has already been acquired, only acquiring an AIT that is newer than the already-acquired AIT. Note that at this time, there is a possibility that a version upgrade occurs for the PAT and the PMT. Thus, whether or not a version upgrade occurs in the PAT and the PMT is continuously monitored, and in the case where a version upgrade actually occurs in the PAT or the PMT, the actual AIT must be re-acquired through the aforementioned method based on the version-upgraded PAT and PMT. The AIT monitoring unit 2402 outputs a newly-acquired AIT to the application status management unit 1804 each time an ALT is newly acquired. A column 2201 is an identifier of the Java program.

According to the MHP standard, this identifier is defined as an Application ID. A column 2202 is control information of the Java program. In the control information, there is “autostart”, “present”, “kill”, and so on; “autostart” means that the terminal apparatus 1300 executes the Java program automatically in an instant, “present” means not performing automatic execution, and “kill” means stopping the Java program. A column 2203 is a DS-MCC identifier for extracting the PID that includes the Java program in the DS-MCC format. A column 2204 is a program name of the Java program. A column 2205 is a service_bound_flag, where 1 means that the Java program will undoubtedly end when a different service is selected. 0 means that when another service is selected, in the case where the Java program that also corresponds to the AIT of that service is denoted, that Java program continues to be executed without being terminated. However, even in the case of 0, the control information of a Java program in a newly-selected service is given priority. Also in the case of 0, when the newly-selected service has not been recorded, execution of the current Java program is continued as-is. Note that in such a case, the configuration may be one in which the Java program is terminated. Here, an EPG application in which selective reproduction can be carried out for a specified service only can be given as an example of a Java program in which the service_bound_flag=0. In other words, by including an identical EPG application in which the service_bound_flag=0 in all services to be selectively reproduced, it is possible to continuously execute the EPG application without termination in the case where each service is selectively reproduced from this EPG application. Rows 2211, 2212, 2213, and 2214 are a group of the information of the Java program. The Java program defined by row 2211 is a combination of the Java program identifier “0x3221”, the control information “autostart”, the DSM-CC identifier “1”, and the program name “a/TopXlet”. The lava program defined in row 2212 is a group including a Java program identifier “0x3222”, the control information “present”, a DSM-CC identifier “1”, and a program name “b/GameXlet”. Here, the three Java programs defined by rows 2211, 2212, and 2214 have the same DSM-CC identifier. This indicates that three Java programs are included in one file system encoded in the DSM-CC format. Here, four types of information are prescribed for the Java program, but in reality, more types of information are defined. Details can be found in the DVB-MHP specifications.

The application status management unit 1804 analyzes the details of the renewed AIT outputted from the AIT monitoring unit 1805, and manages an execution status of the Java program based on that content of the AIT.

First, the application status management unit 1804 finds a Java program with control information of “autostart” from among the AIT, and extracts the corresponding DSM-CC identifier and Java program name. Referring to FIG. 22, the application status management unit 1804 extracts the Java program from the row 2211 and acquires the DSM-CC identifier of “1” and the Java program name of “a/TopXlet”. Next, the application status management unit 2401 uses the DSM-CC identifier acquired from the AIT to access the DSM-CC 1704d, and can fetch a file of the Java program stored in a DSM-CC file system. The file is stored in the primary storage unit 1308, the secondary storage unit 1307, and so on. Fetching data such as the file system from the TS packet in the MPEG-2 transport stream and saving the data into a storage means such as the primary storage unit 1308 and the secondary storage unit 1307 is hereafter called downloading.

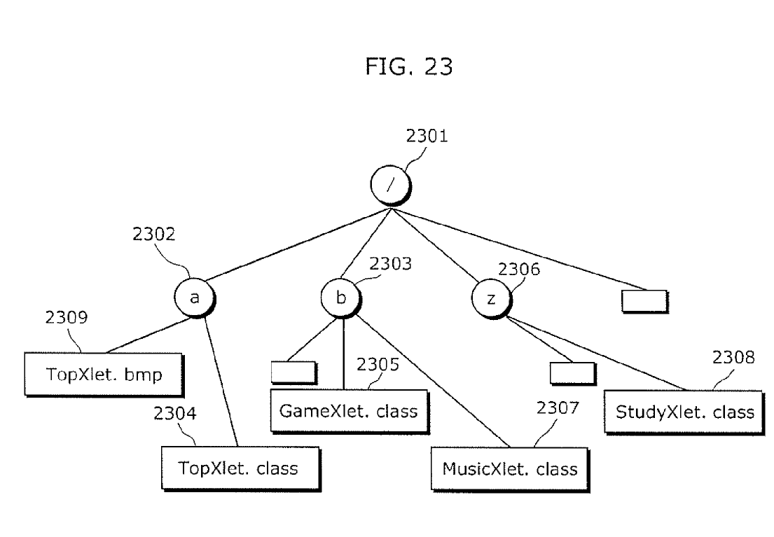

FIG. 23 is an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file “MusicXlet.class”, and 2308 is a file “StudyXlet.class”.

Next, the application status management unit 2401 passes the Java program to be executed to the lava VM 1703, from among the file systems downloaded to the primary storage unit 1308. Here, when the name of the Java program to be executed is “A/TopXlet”, the file “a/TopXlet.class”, in which “.class” is added to the end of the Java program name, is the file to be executed. “/” is a directory and file name division, and referring to FIG. 23, the file 2304 is the Java program which should be executed. The file is executed as the Java program 1806, shown in FIG. 18, in the Java VM 1703.

The application status management unit 1804 analyzes the AIT each time an AIT with a new AIT version is outputted from the AIT monitoring unit 2402 and changes an execution status of a new Java program.

The JMF 1704a handles control of reproduction of the video and audio contained in the service. To be more specific, in the case where the service is reproduced from the recording area 1504 using the configuration in FIG. 16,

An input of the JMF 1704a is a channel identifier of a channel to be reproduced. First, the JMF 1704a searches for channel information in the library 1701b with a specified channel identifier as a key, and obtains the program number. Next, using the SF 1704e and the like, a PAT is acquired from the MPEG-2 transport stream. Then, the PID of the PMT that corresponds to the obtained program number is obtained from the information of the PMT. Once again, using the SF 1704e, the actual PMT is acquired. The acquired PMT is in a format as shown in FIG. 11, and has written the PIDs of elementary streams that have “video” and “sound” as the stream types. When the JMF 1704a sets those PIDs in the PID filter 1502 of the TS decoder 1321 via the library 1701b, the video ES and the audio ES, onto which those PIDs are multiplexed, are decoded by the AV decoder 1303, as shown in FIG. 16. The decoded audio and video are reproduced through the speaker 1304 and the display 1305.

In addition, the JMF 1704a controls trick play of the service. The IMF 1704a provides setRate(float factor) as a Java API for the Java program 1806 to specify the reproduction speed of the service. When the parameter factor is specified to be 1.0, reproduction is to performed at normal speed, whereas when the parameter factor is specified to be 2.0, trick play, with the speed twice as fast as the normal speed, is performed. In addition, when 0.0 is specified, the reproduction speed is 0, or in other words, the reproduction is paused. The JMF1704a notifies the service reproduction speed specified by the factor to a time-shift buffer readout control unit 1803. As a result, the time-shift buffer readout control unit 1803 implements a change in the service reproduction speed by changing the speed at which the MPEG-2 transport stream is read out from the recording area 1504. Details of this process shall be described later.

A time-shift buffer manager 1704h stores the MPEG-2 transport stream outputted from the multiplexer 1313 in the configuration in FIG. 15 in the secondary storage unit. The service specified by the Java program 1806 is included in this MPEG-2 transport stream. FIG. 18 shows an internal configuration of the time-shift buffer manager 1704h. The time-shift buffer manager 1704h includes a time-shift buffer management unit 1801, a time-shift buffer write control unit 1802, and a time-shift buffer read control unit 1803.

The time-shift buffer management unit 1801 newly creates a time-shift buffer, which is the recording area 1504 in the secondary storage unit 1307, in response to a request from the Java program 1806. The time-shift buffer management unit 1801 has createTimeShiftBuffer(intime) as a Java API for newly creating the time-shift buffer. “time” is the minimum length of time of a recorded service that can be stored by the newly-created time-shift buffer. The time-shift buffer must guarantee that a service of this length of time can be recorded. In other words, it is possible to reproduce the service up until the time in the past specified by this “time.” When the Java program 1806 calls the createTimeShiftBuffer(intime), the time-shift buffer management unit 1801 creates a time-shift buffer in the initial state.

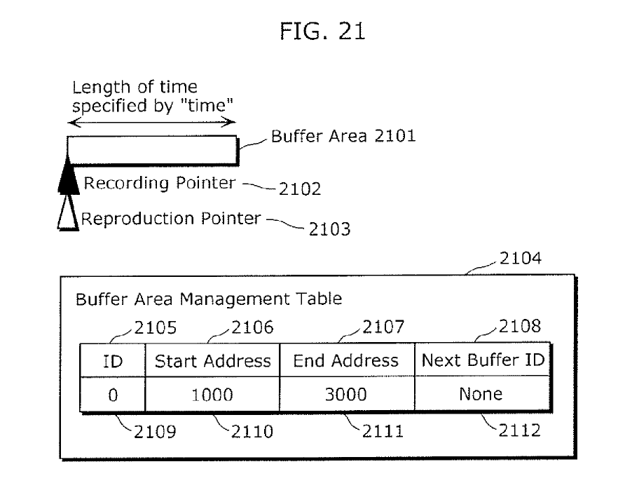

FIG. 21 is a diagram showing the initial state of the internal structure of the recording area 1504, or in other words, the time-shift buffer. A buffer area 2101, of the length of time specified by the “time,” is secured as an area for recording the MPEG-2 transport stream. A recording pointer 2102, which indicates a write position of the MPEG-2 transport stream, and a reproduction pointer 2103, which indicates a read position of the MPEG-2 transport stream, are set in the buffer area. These pointers are logical pointers that indicate addresses within the buffer area. At the same time, a buffer area management table 2104, for recording information of the buffer area, is created. The buffer area management table 2104 stores an ID 2105, a start address 2106, an end address 2107, and a next buffer ID 2108, for each buffer area. The ID 2105 is a unique ID allotted to each buffer. The start address 2106 is a start address, in the secondary storage device 1307, for each buffer area. The end address 2107 is an end address, in the secondary storage device 1307, for each buffer area. The next buffer ID 2108 is an ID of the next buffer area that should be read out after the MPEG-2 transport stream of the present buffer so area has been completely read out. This buffer area management table 2104 is updated whenever a buffer area is created, deleted, and so on. When createTimeShiftBuffer(intime) is called, the time-shift buffer management unit 1801 first creates a single buffer area 1801 in the initial state. Then, the time-shift buffer management unit 1801 creates a new entry in the buffer area management table 2104, and writes the ID, start address, and end address of the buffer area 1801 therein. At this time, the buffer area 1801 is created, and an ID of 0 (2109 in FIG. 21), a start address of 1000 (2110 in FIG. 21), an end address of 3000 (2111 in FIG. 21), and a next buffer ID of None (because there is no next buffer ID) (2112 in FIG. 21) is written. The recording pointer 2102 and the reproduction pointer 2103 are positioned at the start address of this buffer area.

When creation of the buffer area in the initial state finishes, the time-shift buffer management unit 1801 causes the time-shift buffer write control unit 1802 to commence processing for recording the output of the MPEG-2 transport stream outputted by the multiplexer 1313, and furthermore causes the time-shift buffer read control unit 1803 to commence processing for reading out the MPEG-2 transport stream from the recording area 1504, or the time-shift buffer created at this time, and outputting the MPEG-2 transport stream to the TS decoder.

The time-shift buffer write control unit 1802 advances the recording pointer in accordance with the write status while writing the MPEG-2 transport stream outputted by the multiplexer 1313 shown in FIG. 15 into the buffer area created in the recording area 1504. After that, in the case where all of the secured buffer areas have been filled up, a new buffer area is created, and the buffer area management table is updated.

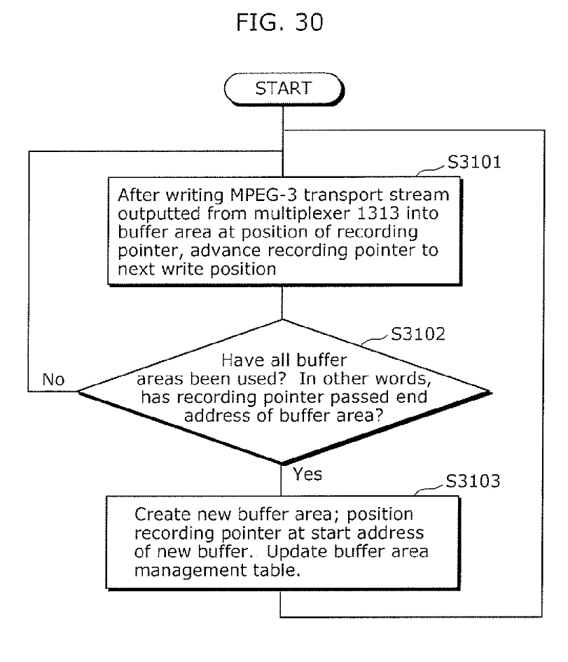

FIG. 30 shows a flowchart that expresses the operation of the time-shift buffer write control unit 1802. First, in S3101, the time-shift buffer write control unit 1802 writes the MPEG-2 transport stream outputted by the multiplexer 1313 in the buffer area at the position of the recording pointer, and after the write, advances the recording pointer to the next write position. Next, the process moves to S3102, and it is judges whether or not all the buffer areas have been filled up by the writing of the MPEG-2 transport stream, or in other words, whether the recording pointer has passed the end address of the buffer area.

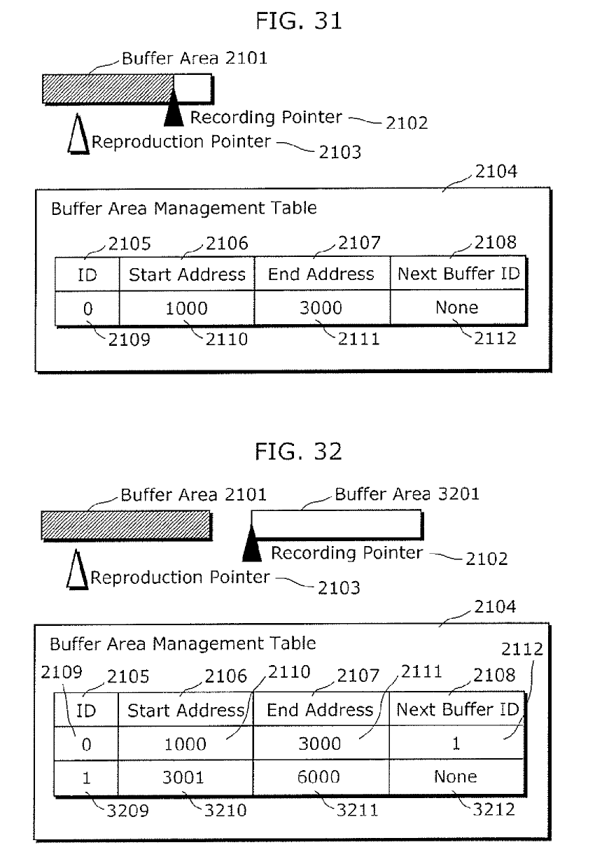

If, in S3102, the recording pointer has not passed the end address of the buffer area, the process returns to S3101, and the write processing of for the MPEG-2 transport stream continues. FIG. 31 shows the status of the recording area 1504 in a situation where the write processing for the MPEG-2 transport stream is continued. The MPEG-2 transport stream written into the buffer area 2101 is indicated by the shaded pattern. The recording pointer is in the next write position for the MPEG-2 transport stream. If, in S3102, the recording pointer has passed the end address of the buffer area, the process proceeds to S3103. In S3103, a buffer area is newly created, and the recording pointer is positioned at the start address of the new buffer. The newly-created buffer area may be created identical to the buffer area 2101 in the initial state; however, it must be placed so as not to overlap with other buffer areas. When the buffer area has been created, a new entry is created in the buffer area management table; information of the buffer created at this time is written and the table is updated thereby. FIG. 32 shows the state of the recording area 1504 when the buffer area has been newly created. The newly-created buffer area is a buffer area 3201. The recording pointer 2102 is positioned at the start of the newly-created buffer area 3201. In addition, a new entry, for the buffer area 3201, has been added to the buffer area management table 2104. In accordance with the buffer area 3201, an ID of 1 is allocated (3209 in FIG. 32), and a start address of 3001 (3210 in FIG. 32), an end address of 6000 (3211 in FIG. 32), and a next buffer ID of None (3212 of FIG. 32) are written into the table. Furthermore, 1 is written into the next buffer ID for the buffer with an ID of 0 (2112 in FIG. 32). This means that the MPEG-2 transport stream is written into the buffer 2101, which has an ID of 0, and the buffer 3201, which has an ID of 1, so as to be continuous, and that these buffers are read out and the MPEG-2 transport stream reproduced continuously at the time of reproduction.

After this, the process returns to S3101, and writing of the MPEG-2 transport stream to the position of the recording pointer continues.

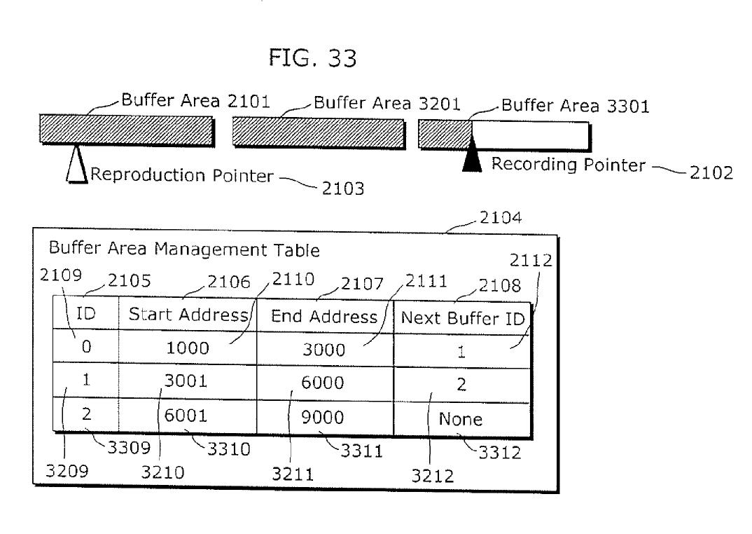

FIG. 33 shows a state in which the processing described above is continued, a buffer area 3301 with an ID of 3 is created, and the MPEG-2 transport stream is written. The recording pointer 2102 is located on the buffer area 3301. The entry with an ID of 3 is information of the buffer area 3301; the ID of 3 has been allocated 1.5 (3309 in FIG. 33), and the start address is 6001 (3310 in FIG. 33), the end address is 9000 (3311 in FIG. 33), and the next buffer ID is None (3312 in FIG. 33).

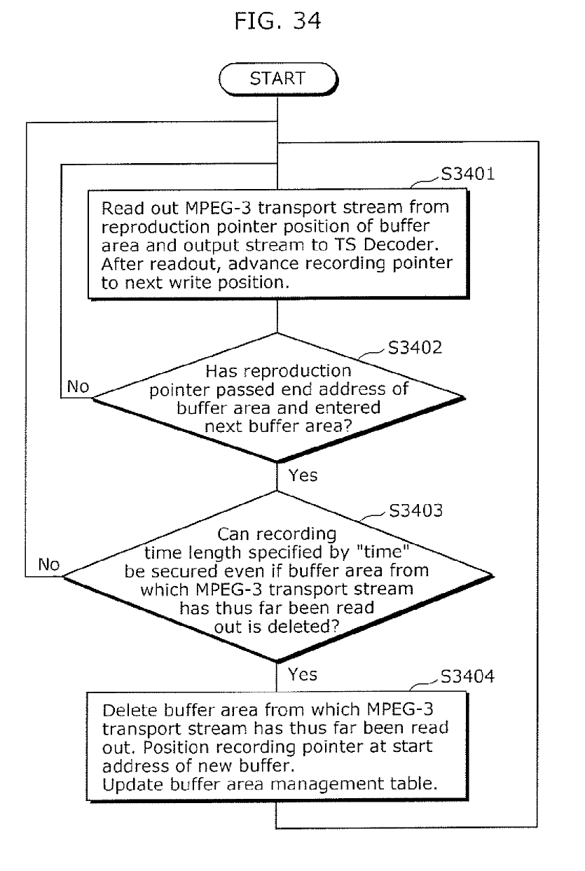

The time-shift buffer read control unit 1803 reads out, from the recording area 1504 created in the recording area 1504, or in no other words, from the time-shift buffer created by the time-shift buffer management unit 1801, the time-shift buffer write control unit 1802, or the like, the MPEG-2 transport stream in accordance with the service reproduction speed specified by the JMF 1704a, and outputs the read-out MPEG-2 transport stream to the TS decoder. FIG. 34 shows a flowchart that expresses the operation of the time-shift buffer read control unit 1803. First, in S3401, the time-shift buffer write control unit 1802 reads out the MPEG-2 transport stream at the position of the reproduction pointer in the buffer area, and outputs this to the TS decoder After the readout, the time-shift buffer write control unit 1802 advances the recording pointer to the next write position. Next, the process proceeds to S3402, where it is judged whether or not all of the MPEG-2 transport stream within the present buffer area has been read out, or in other words, whether or not the reproduction pointer has passed the end address of the buffer area.

If, in S3402, the reproduction pointer has not passed the end address of the buffer area, the process returns to S3401, and the read processing for the MPEG-2 transport stream continues. For example, in the recording area 1504 shown in FIG. 31, in which the write processing for the MPEG-2 transport stream has been continued, the MPEG-2 transport stream written into the buffer area 2101 is read from the position of the reproduction pointer 2103. In this case, the end address of the buffer area 2101 has not been passed, and thus reading of the MPEG-2 transport stream continues from the position of the reproduction pointer.

If, in S3402, the recording pointer has passed the end address of the buffer area, the process proceeds to S3403. In S3403, even if the buffer area from which the MPEG-2 transport stream had thus far been read out is deleted, it is judged whether or not a recorded service of the length of time specified by the “time” of the createTimeShiftBuffer(intime) of the JMF 1704a has been secured. In the present embodiment, the lengths of individual buffer areas are the lengths of time specified by “time”; thus, if the reproduction pointer is not positioned within the same buffer area as the recording pointer, a recorded service of at least the length of time specified by “time” will be secured. In other words, two buffer areas are always present.

If the necessary recorded service has not been secured, the process proceeds to S3401, and the read processing continues.

If the necessary recorded service has been secured, the process proceeds to S3404. In the present embodiment, if the reproduction pointer and the recording pointer are positioned within the same buffer area, the process proceeds to S3401. In other cases, the process proceeds to S3404.

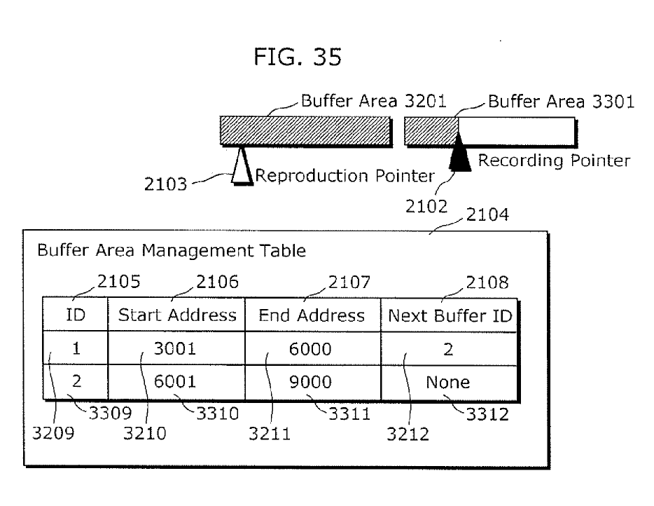

In S3404, the buffer area from which the MPEG-2 transport stream had thus far been read out, or in other words, the buffer area in which the reproduction pointer has passed the end address, is deleted. At this time, the reproduction pointer is positioned somewhere within the next buffer. (For example, when trick play is being performed, the reproduction pointer is not necessarily positioned at the start address.) Furthermore, the entry for the deleted buffer area is deleted from the buffer area management table, and the table is updated. For example, as shown in FIG. 33, reproduction proceeds from the state where the reproduction pointer 2103 is in the buffer area 2101 with an ID of 0, and in the case where reproduction has shifted to a state in which the reproduction pointer 2103 is in the buffer area 3201 with an ID of 1, as shown in FIG. 35, the buffer 2101 with an ID of 0 is deleted. As a result, the buffer area management table 2104 becomes as shown in FIG. 3S. In other words, the entry with an ID of 0 (2109 in FIG. 33), a start address of 1000 (2110 in FIG. 33), an end address of 3000 (2111 in FIG. 33), and a next buffer ID of 1 (2112 in FIG. 33) is deleted.

After that, the process returns to S3401, and readout of the MPEG-2 transport stream continues from the position of the reproduction pointer.

The service manager 1704f manages playback of the service that has been time-shift recorded so that i) the MPEG-2 transport stream which includes the video ES, audio ES, and private section that make up the service indicated by the channel identifier specified by the Java program 1806 is inputted into the recording area 1504 and ii) the service included in the MPEG-2 transport stream outputted from the recording area 1504 is reproduced.

The service manager 1704f provides select(intservice_id) as a Java API for specifying the service which the Java program 1806 wishes to reproduce. service_id expresses the channel identifier. When the Java program calls select(intservice_id), the service manager 1704f uses the channel identifier as a key to obtain tuning information, which corresponds to the channel identifier, from channel information held by the library 1701b. After that, when the tuning information is provided to the Tuner 1704c, the Tuner 1704c commences tuning. Here, the tuning information is information that can specify a frequency, a modulation method, and the like. Next, using the SF 1704e, the service manager 1704f acquires the PAT from the MPEG-2 transport stream obtained through the tuning. In addition, the recorded service selection unit 2404 searches for the program number that corresponds to the specified channel identifier from the library 1701b, and checks the corresponding PMT. After that, the PID of the PMT, which corresponds to the specified channel, is acquired from the PAT, and using the SF 1704e, the PMTs within the MPEG-2 transport stream are acquired. Note that in the MPEG standard, the version of the PAT and the PMT may be upgraded. Accordingly, a recorded service selection unit 2404 constantly filters and monitors the PAT and PMT, performs the above processing again when the version of either the PAT or the PMT is upgraded, and obtains the PMT corresponding to the specified channel identifier. All PIDs and table_ids of all the ESs denoted in the PMT, or in other words, the audio, video, and section ES that make up the service, are set in the PID filter 1502 and the section filter 1503 of the TS decoder. After that, as shown in FIG. 15, an input and output of the hardware constituent elements are set so that the MPEG-2 transport stream is inputted into the TS decoder via the adapter 1311. Then, in accordance with the flow described in FIG. 15, all ESs that make up a desired service are inputted into the recording area 1504, and are recorded into the recording area 1504 via the time-shift buffer write control unit 1802 described earlier.

At the same time, the specified service from the MPEG-2 transport stream recorded in the recording area 1504 through the above-mentioned procedure is reproduced. Through the library 1701b, the service manager 1704f sets the output destination of each hardware constituent element to flow through the path shown in FIG. 16. After that, the channel identifier of the channel that should be reproduced from the MPEG-2 transport stream outputted from the recording area 1504 is provided to the JMF 1704a. Then, through the process described above, the JMF 1704a starts reproduction of the audio and video multiplexed into the MPEG-2 transport stream outputted from the secondary storage unit 1307. Furthermore, the service manager 1704f provides the channel identifier of the channel that should be reproduced to the AIT monitoring unit 2402 of the AM 1704b. Then, in accordance with the AIT multiplexed into the MPEG-2 transport stream outputted from the secondary storage unit 1307 via the TS decoder 1302, the AM 1704b commences execution and termination of the Java program multiplexed into the same MPEG-2 transport stream

The EPG 1702 is an Electric Program Guide, and is a function which allows a user to choose a TV show to be recorded and reproduced. Normal reproduction through receiving a broadcast wave is out of the scope of the present invention and thus description is omitted. The EPG 1702 is implemented as the Java program 1806. Alternatively, the ERG 1702 may be a Java program downloaded via a method aside from that described above. A method of sending application control information known as an XAIT, which is similar to the AIT, is defined in the aforementioned OCAP (Open Cable Application Platform) OC-SP-OCAP 1.0-I16-050803 specifications. The EPG 1702 may be a Java program downloaded using this XAIT. The present invention does not depend on the method of downloading the EPG 1702.

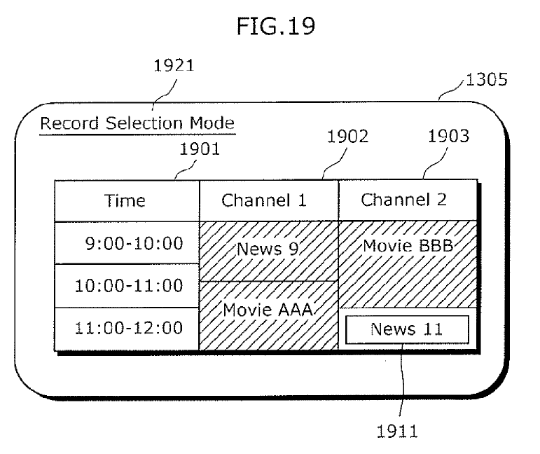

The EPG 1702 displays a list of broadcasted TV shows, and allows the user to choose a desired TV show. FIG. 19 is an example of a screen display for allowing selection of a TV show that is to be recorded. A time 1901 and channels 1902 and 1903 are displayed in a grid, and it is possible to check the TV shows of each recordable channel at each time. It is possible for the user to move a focus 1911 within the screen by using up, down, right, and left cursor buttons 1401 to 1404, which are included in the input unit 1310 of the terminal apparatus 1300. Furthermore, when an OK button 1405 is pushed, the TV show which the focus currently highlights is selected to be recorded. The EPG 1702 acquires the channel identifier of the TV show from the library, and when the TV show to be recorded is selected by the user, notifies the channel identifier of that TV show to the service manager 1704f.

A typical process of the present embodiment configured as described above shall be shown hereafter.

First, when the EPG 1702, which is the lava program 1806, calls the createTimeShiftBuffer(intime) which is provided by the time-shift buffer management unit 1801, the time-shift buffer write control unit 1802 commences the recording processing, and the time-shift buffer read control unit 1803 commences the read processing. Next, when the same EPG 1702 calls the select(intservice_id) provided by the service manager 1704f, the MPEG-2 transport stream is recorded into the recording area 1504 located within the secondary storage unit 1307, or in other words, into the time-shift buffer area, in accordance with the recording processing flow shown in FIG. 15, and furthermore, the same MPEG-2 transport stream is read out from the recording area 1504, or in other words, from the time-shift buffer area, in accordance with the reproduction processing flow shown in FIG. 16, and the service is reproduced. In the case where the Java program is included within the service, the lava program is executed by the AM 1704b in accordance with the AIT control information.

According to the present embodiment, the configuration of the time-shift buffer implemented by adding a buffer area, rather than through a conventional ring buffer; therefore, it is possible to continue recording without forcefully changing the playback position, even in the case where pause, slow-motion playback, or the like are performed through trick-play.

It should be noted that in the present embodiment, there is no particular limit on the total number of buffer areas to be secured, but the present embodiment may take on a configuration in which the total number of buffer areas is limited, through a volume limit placed on the secondary storage unit 1307 or the like. In such a case, a configuration may be utilized in which recording can be continued without forcefully changing the reproduction position until the total number of buffer areas reaches the limit, and the reproduction pointer is forcefully moved to the start address of the next buffer only when the total number of buffer areas has reached the limit. Alternatively, the configuration may be one in which the total number of buffer areas is fixed. In addition, the size of each buffer area does not need to be a fixed length, and all buffer areas do not need to be the same size.

### Second Embodiment

Hereafter, an apparatus and a method according to the second embodiment of the present invention shall be described with reference to the drawings.

A hardware configuration used in the present embodiment is configured as shown in FIG. 13. As this has the same configuration and function as in the first embodiment, descriptions are omitted. In the present embodiment, each hardware constituent element has the following input and output setting.

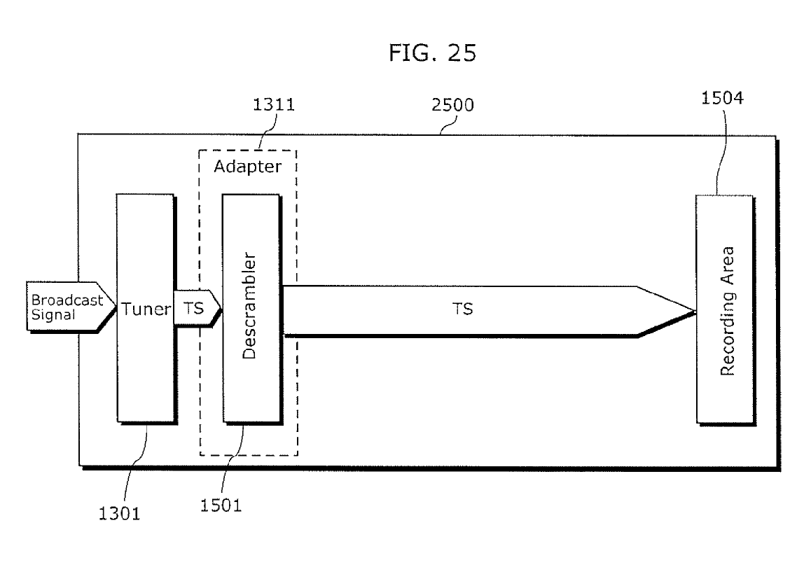

First, FIG. 25 shows a conceptual rendering which expresses the physical connection sequence, processing content, and input/output data format of each device, in the case where of an MPEG-2 transport stream that transports a service is recorded. 2500 is terminal apparatus, which includes a tuner 1301, adapter 1311, a descrambler 1501, and a recording area 1504. Constituent elements in FIG. 15 that have the same reference numbers as in FIG. 13 have the same functions and thus description is omitted. First, the tuner 1301 performs tuning on the broadcast wave in accordance with a tuning instruction provided by the CPU 1306. The tuner 1301 demodulates the broadcast wave and inputs the MPEG-2 transport stream into the adapter 1311. The descrambler 1501, which is within the adapter 1311, descrambles the MPEG-2 transport stream based on limitation removal information for each viewer. The descrambled MPEG-2 transport stream is recorded into the secondary storage unit.

Finally, FIG. 16 shows a conceptual rendering which expresses the physical connection sequence and processing content of each device, as well as the input/output data format, during recording of the service. Because this is the same configuration as described in the first embodiment, descriptions are hereby omitted.

Thus far, an example of a hardware configuration regarding the present invention has been described, Hereafter, a chief function of the present invention, which is control of recording and reproduction of the service via a Java program, is described.

A software configuration used in the present embodiment is configured as shown in FIG. 17 and FIG. 18. In addition, FIG. 19 to FIGS. 23 and 30 to 35 used in the first embodiment are used again here to describe configurations of each type of data and a screen configuration.

Regarding FIG. 17 and FIG. 18, constituent elements aside from the service manager 1704f are identical to those described in first embodiment, and therefore descriptions shall not be repeated. The service manager 1704f manages playback of the service that has been time-shift recorded so that i) the MPEG-2 transport stream which includes the service indicated by the channel identifier specified by the Java program 1806 is inputted into the recording area 1504 and ii) the service included in the MPEG-2 transport stream outputted from the recording area 1504 is reproduced.

The service manager 1704f provides select(intservice_id) as a Java API for specifying the service which the Java program 1806 wishes to reproduce. service_id expresses the channel identifier. When the Java program calls select(intservice_id), the service manager 1704f uses the channel identifier as a key to obtain tuning information, which corresponds to the channel identifier, from channel information held by the library 1701b. After that, when the tuning information is provided to the Tuner 1704c, the Tuner 1704c commences tuning. Here, the tuning information is information that can specify a frequency, a modulation method, and the like. After that, as shown in FIG. 25, an input and output of the hardware constituent elements are set so that the MPEG-2 transport stream is inputted into the recording area 1504 via the adapter 1311. Then, in accordance with the flow described in FIG. 25, the entire MPEG-2 transport stream that includes the desired service is inputted into the recording area 1504, and is recorded into the storage area 1504 by the time-shift buffer write control unit 1802 described earlier.

At the same time, the specified service from the MPEG-2 transport stream recorded in the recording area 1504 through the above-mentioned procedure is reproduced. Through the library 1701b, the service manager 1704f sets the output destination of each hardware constituent element to flow through the path shown in FIG. 16. After that, the channel identifier of the channel that should be reproduced from the MPEG-2 transport stream outputted from the recording area 1504 is provided to the JMF 1704a. Then, through the process described above, the JMF 1704a commences reproduction of the audio and video multiplexed into the MPEG-2 transport stream outputted from the secondary storage unit 1307. Furthermore, the service manager 1704f provides the channel identifier of the channel that should be reproduced to the AIT monitoring unit 2402 of the AM 1704b. Then, in accordance with the AIT multiplexed into the MPEG-2 transport stream outputted from the secondary storage unit 1307 via the TS decoder 1302, the AM 1704b commences execution and termination of the lava program multiplexed into the same MPEG-2 transport stream.

A typical process of the present embodiment configured as described above is shown hereafter.

First, when the EPG 1702, which is the lava program 1806, calls the createTimeShiftBuffer(intime) which is provided by the time-shift buffer management unit 1801, the time-shift buffer write control unit 1802 commences the recording processing, and the time-shift buffer read control unit 1803 commences the read processing. Next, when the same EPG 1702 calls the select(intservice_id) provided by the service manager 1704f, the MPEG-2 transport stream is recorded into the recording area 1504 located within the secondary storage unit 1307, or in other words, into the time-shift buffer area, in accordance with the recording processing flow shown in FIG. 15, and furthermore, the same MPEG-2 transport stream is read out from the recording area 1504, or in other words, from the time-shift buffer area, in accordance with the reproduction processing flow shown in FIG. 16, and the service is reproduced. In the case where the Java program is included within the service, the Java program is executed by the AM 1704b in accordance with the AIT control information.

According to the present embodiment, the configuration of the time-shift buffer implemented by adding a buffer area, rather than through a conventional ring buffer; therefore, it is possible to continue recording without forcefully changing the playback position, even in the case where pause, slow-motion playback, or the like are performed through trick-play. In addition, when recording to the recording area, or in other words, to the time-shift buffer, the MPEG video ES and audio ES do not need to be decoded and re-encoded, and thus a crop in image quality caused by re-encoding can be prevented.

It should be noted that in the present embodiment, there is no particular limit on the total number of buffer areas to be secured, but the present embodiment may take on a configuration in which the total number of buffer areas is limited, through a volume limit placed on the secondary storage unit 1307 or the like. In such a case, a configuration may be utilized in which recording can be continued without forcefully changing the reproduction position until the total number of buffer areas reaches the limit, and the reproduction pointer is forcefully moved to the start address of the next buffer only when the total number of buffer areas has reached the limit. Alternatively, the configuration may be one in which the total number of buffer areas is fixed. In addition, the size of each buffer area does not need to be a fixed length, and all buffer areas do not need to be the same size.

### Third Embodiment

Hereafter, an apparatus and a method according to the third embodiment of the present invention shall be described with reference to the drawings.

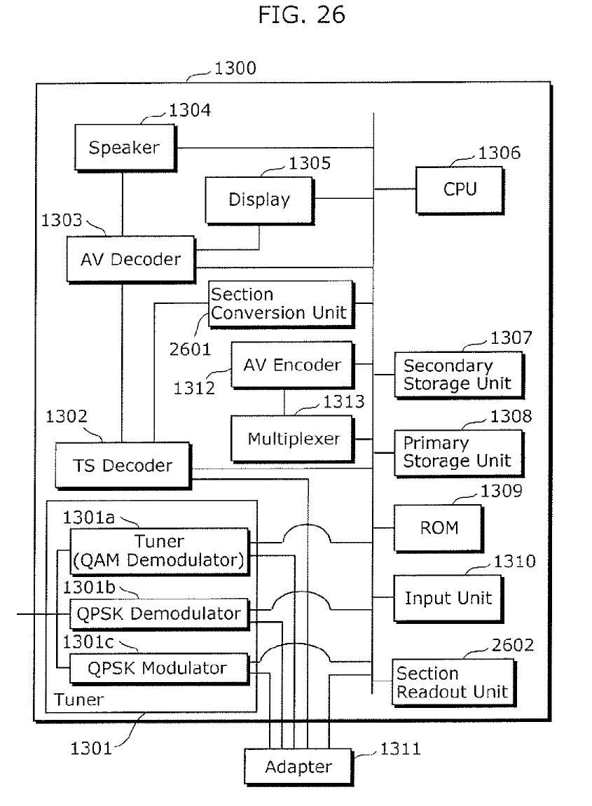

FIG. 26 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is a broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313; a section conversion unit 2601; and a section readout unit 2602. Aside from the multiplexer 1313, the section conversion unit 2601, and the section readout unit 2602, elements that have the same names and numbers as those described in FIG. 13 in the first embodiment are identical to those described in the first embodiment, and therefore descriptions shall not be repeated.

The multiplexer 1313 differs from that of the first embodiment in that it does not multiplex an AIT section and a DSM-CC section. Aside from that, the multiplexer 1313 is the same.

The section conversion unit 2401 converts a section not multiplexed by the multiplexer into a file and records the file in the recording area 1504 of the secondary storage unit 1307. After passing through the primary storage unit 1308, the AIT section and DSM-CC section filtered by the TS decoder 1302 pass through the section conversion unit 2401 and are recorded into the recording area 1504, without passing through the multiplexer. Here, a recording method when recording the section into the recording area 1504 differs depending on the format of the section.

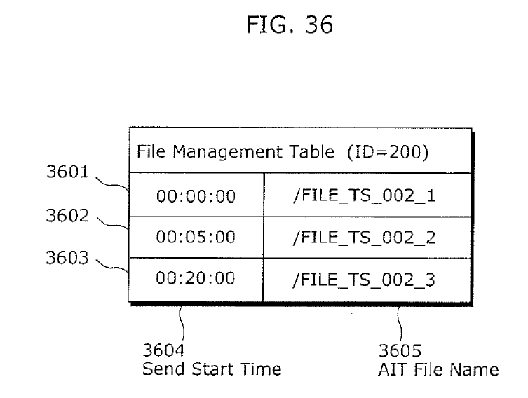

In the case of a file system recorded within an MPEG-2 transport stream in the DSM-CC file system format, the section conversion unit 2401 converts this file system into a file system format unique to the recording area 1504, which is in turn unique to a terminal, and records the file system into the recording area 1504. The storage location of the file recorded in the unique file system format is recorded in combination with the send time of the file into the recording area 1504 in the file management table format shown in FIG. 36. In each of lines 3601, 3602, and 3603 shown in FIG. 36, directories in which different DSM-CC file systems have been converted and stored are written. Column 3605 holds directory names, and column 3604 holds the time at which each directory has commenced sending. Each time a DSM-CC file system is newly sent, a new entry is added to the file management table in FIG. 36. In other words, a new line is added, and the directory name and send start time is written Each time a buffer area is newly created within the recording area 1504, the section conversion unit 2401 creates a new file management table in association with that buffer area. The DSM-CC file system sent along with the video and audio recorded in that buffer area is written into the file management table that corresponds to that buffer area. A unique ID is allocated to each file management table.

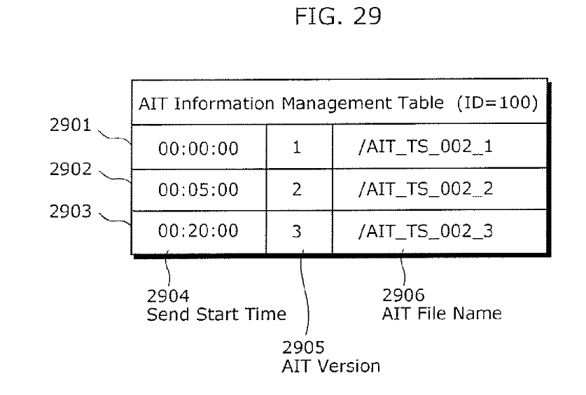

In addition, regarding the AIT, the section conversion unit 2401 converts the AIT into a binary format and records it into the recording area 1504. The storage location of the AIT binary file is recorded in combination with the send time of the AIT into the recording area 1504 in the AIT information management table format shown in FIG. 29. In each of lines 2901, 2902, and 2903 shown in FIG. 29, directories in which different AIT binary files have been converted and stored are written. Column 2906 holds directory names, column 2905 holds the AIT version, and column 2904 holds the time at which the AIT has commenced sending. Each time a new version of the AIT is sent, a new entry is added to the AIT information management table shown in FIG. 36. In other words, a new line is added, and the directory name, version, and send start time is written. Each time a buffer area is newly created within the recording area 1504, the section conversion unit 2401 creates a new AIT information management table in association with that buffer area. The AIT sent along with the video and audio recorded in that buffer area is written into the AIT information management table that corresponds to that buffer area. A unique ID is allocated to each AIT information management table.

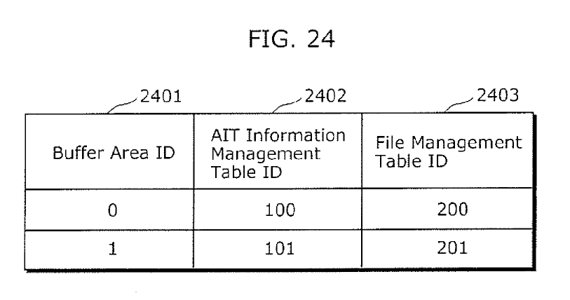

Each time a buffer area is newly created in the recording area 1504, the section conversion unit 2401 creates a file management table and an AIT information management table. Furthermore, a private section management table, indicated in FIG. 24, which is within the recording area 1504 is updated so that the correspondence between the created tables and the buffer areas can be managed. The private section management table is a table that holds a combination of the buffer area and the file management table and AIT information management table that corresponds to that buffer area. Information for each buffer area is written one line at a time. Column 2401 is a buffer area ID for specifying the buffer area; column 2402 is an AIT information management table ID for specifying the AIT information management table the corresponds to the buffer area; and column 2403 is a file management table ID for specifying the file management table that corresponds to the buffer area. In the example shown in FIG. 24, information regarding the buffer area with an ID of 0 is written in line 2405, and information regarding the buffer area with an ID of 1 is written in line 2405.

Here, the tables created by the section conversion unit 2401 are created and deleted in synchronization with the creation and deletion of the buffer areas. The timing of creation and deletion shall be described later. Whenever the time-shift buffer management unit 1801 or the time-shift buffer write control unit 1802 newly creates a buffer area, the section conversion unit 2401 creates a file management table and an AIT information management table, and furthermore adds a line corresponding to the buffer area to the private section management table and fills in the information. After that, as described earlier, the section conversion unit 2401 updates the AIT information management table and the file management table each time the AIT and DSM-CC file systems are sent. For example, in the case where the recording area 1504 has transited from the state shown in FIG. 31 to the state shown in FIG. 32, or in other words, the case where the buffer area 3201, which has an ID of 1, is newly created, line 2405 in FIG. 24, which concerns the buffer area with an ID of 1, is added and the information written therein. On the other hand, each time the time-shift buffer read control unit 1803 deletes a buffer area, the section conversion unit 2401 deletes the file management table, the DSM-CC file system which has been recorded after undergoing format conversion, the AIT information management table, and the AIT file, and furthermore deletes the line that corresponds to the buffer area from the private section management table. For example, in the case where the recording area 1504 has transited from the state shown in FIG. 33 to the state shown in FIG. 35, or in other words, the case where the buffer area 2101, which has an ID of 0, is deleted, line 2404 in FIG. 24, which concerns the buffer area with an ID of 0, is deleted; furthermore, the AIT information management table with an ID of 100, which is referred to in that line, and the ATT binary file referred to thereby are deleted, and in addition, the file management table with an ID of 200, the directory referred to thereby, and the directories and files contained within that directory, are deleted.

In an actual broadcast wave, AITs with the same AIT version are repeatedly transmitted any number of times, but in the present embodiment, by detecting a change in the received ATT version, only the first AIT that is updated at that point in time is recorded into the recording area 1504. The same applies to the DSM-CC file system.

The section readout unit 2602 outputs the AIT binary file and the DSM-CC file system to the primary storage unit 1308 based on the AIT information management table and the file management table the correspond to the buffer area within the recording area 1504 in which the reproduction pointer is currently performing reproduction. The section readout unit 2602 first confirms the position of the reproduction pointer within the recording area 1504, and then isolates the ID of the buffer area in which the reproduction pointer is currently performing reproduction. After that, referring to the private section management table in FIG. 24, the section readout unit 2602 isolates the line in which the ID of the buffer area in question is written. The section readout unit 2602 furthermore acquires the ID of the AIT information management table denoted in that line, and isolates the AIT information management table indicated by that ID. Then, the section readout unit 2602 calculates the time of the reproduction pointer position based on the relative position relationship between the current position of the reproduction pointer and the recording time, and referring to the AIT information management table, isolates the AIT binary file that corresponds to that time. Next, the isolated AIT binary file is outputted. In the same manner, for the DSM-CC file system, the private section management table in FIG. 24 is referred to, and the line in which the ID of the buffer area in question is written is isolated. Furthermore, the ID of the file management table denoted in that line is acquired, and the file management table indicated by that ID is isolated. Then, the section readout unit 2602 calculates the time of the reproduction pointer position based on the relative position relationship between the current position of the reproduction pointer and the recording time, and referring to the file management table, isolates the directory name that corresponds to that time. Next, the directories and files contained within the isolated directory are outputted.

As a result, the AIT monitoring unit 2402, Java VM 1703, and the like do not refer to a filtering result of the TS decoder as in the first embodiment, but rather obtain an AIT binary File and a DSM-CC file system from the section readout unit 2602, as shall be described later.

FIG. 14 is an example of the configuration of the input unit 1310 in the present embodiment. Because this is the same as described in the first embodiment, descriptions shall not be repeated.

A process in which the broadcast recording and reproduction apparatus described above records a service contained in a broadcast wave into the secondary storage unit 1307, and a process where the broadcast recording and reproduction apparatus consecutively reads out and reproduces the service from the secondary storage unit 1307, shall be described hereafter in detail.

First, the process in which the service contained in the broadcast wave is recorded into the secondary storage unit 1307 shall be described.

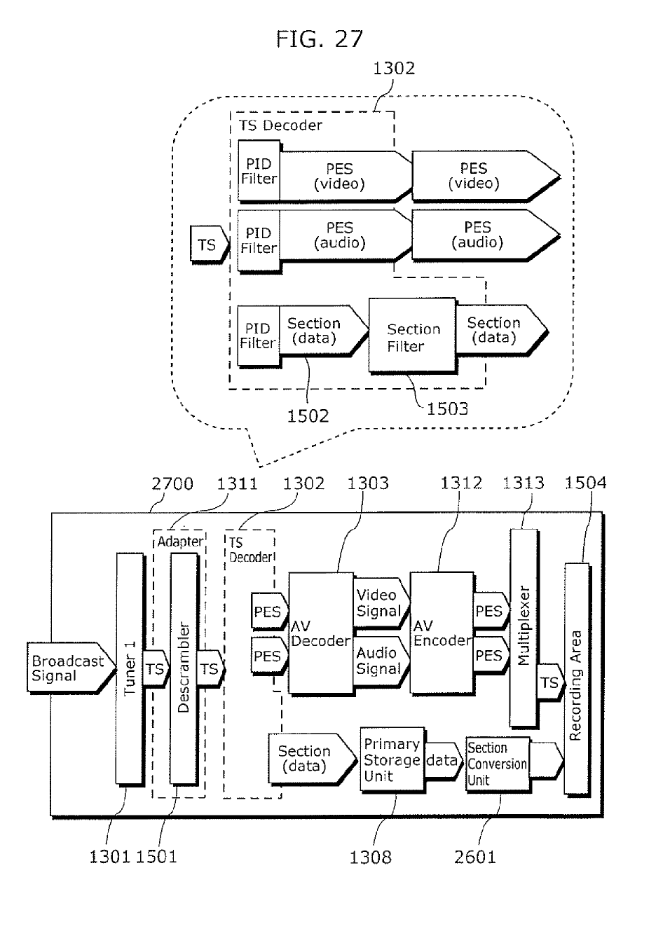

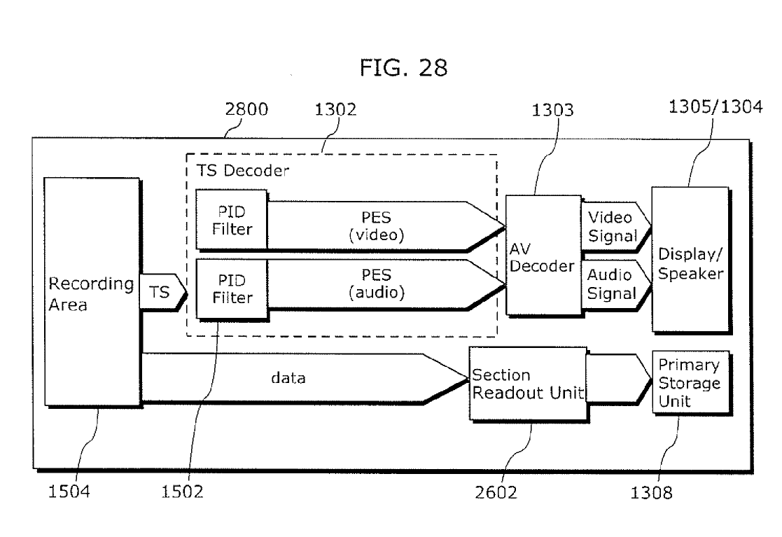

FIG. 27 shows a conceptual rendering which expresses the physical connection sequence and processing content of each device and an input/output data format during recording of the service. Constituent elements in the figure that have identical numbers to the constituent elements shown in FIG. 15 have already been described in the first embodiment, and therefore descriptions shall not be repeated. As opposed to FIG. 15, with the hardware configuration shown in FIG. 27, after passing through the primary storage unit 1308, the AIT section and the DSM-CC section that are filtered by the TS decoder 1302 pass through the section conversion unit 2601 and are recorded to the recording area 1504 without passing through the multiplexer.

Next, description shall be given regarding a process in which the recorded MPEG-2 transport stream is sequentially read out from the secondary storage unit 1307 and the service reproduced.

FIG. 28 shows a conceptual rendering which expresses the physical connection sequence and processing content of each device and an input/output data format during recording of the service. Constituent elements in the figure that have identical numbers to the constituent elements shown in FIG. 16 have already been described in the first embodiment, and therefore descriptions shall not be repeated.

The hardware configuration of FIG. 28 differs from that in FIG. 16 in that the section recorded into the recording area 1504 is read into the primary storage through the section readout unit 2901 by primary storage without passing through the TS decoder.

Thus far, an example of a hardware configuration regarding the present invention has been described. Hereafter, a chief function of the present invention, which is control of recording of the service and control of trick play via a Java program, shall be described.

A software configuration used in the present embodiment is configured as shown in FIG. 17 and FIG. 18. In addition, FIG. 19 to FIG. 23 and FIG. 30 to FIG. 35, used in the first embodiment, are used again here to describe configurations of each type of data and a screen configuration.

Regarding FIG. 17 and FIG. 18, constituent elements aside from the application status management unit 2401, the AIT management unit 2402, the Java VM 1703, and the service manager 1704 are identical to those described in first embodiment, and therefore descriptions are omitted.

In the present embodiment, the AIT monitoring unit 2402 is a partly modified version of the AIT monitoring unit 2402 in the first embodiment, and differs in that instead of filtering and acquiring the AIT multiplexed into the MPEG-2 transport stream read out from the secondary storage unit 1307, the AIT monitoring unit 2402 reads out an AIT file that has been separately recorded into the secondary storage unit 1307. The AIT monitoring unit 2402 reads the AIT file outputted by the section readout unit 2602. Processes aside from this are the same as those of the AIT monitoring unit 3231 of the first embodiment.

The application status management unit 2401 of the present embodiment is a partly modified version of the application status management unit 2401 of first embodiment, and reads out a Java class file recorded in an original file system format from the secondary storage unit 1307, instead of reading out a Java program read from the DSM-CC section multiplexed with the MPEG-2 transport stream. Processes aside from this are the same as those of the application status management unit in the first embodiment.

The Java VM 1703 of the present embodiment is a partly modified version of the Java VM 1703 of the first embodiment, and reads out a Java class file recorded in an original file system format from the secondary storage unit 1307, instead of reading out a Java program read from the DSM-CC section multiplexed with the MPEG-2 transport stream. Processes aside from this are the same as those of the application status management unit in the first embodiment.

The service manager 1704f manages playback of the service that has been time-shift recorded so that i) the MPEG-2 transport stream which includes the video ES, audio ES, and private section that make up the service indicated by the channel identifier specified by the Java program 1806 is inputted into the recording area 1504 and ii) the service included in the MPEG-2 transport stream outputted from the recording area 1504 is reproduced.

The service manager 1704f provides select(intservice_id) as a Java API for specifying the service which the Java program 1806 wishes to reproduce. service_id expresses the channel identifier. When the Java program calls select(intservice_id), the service manager 1704f uses the channel identifier as a key to obtain tuning information, which corresponds to the channel identifier, from channel information held by the library 1701b. After that, when the tuning information is provided to the Tuner 1704c, the Tuner 1704c commences tuning. Here, the tuning information is information that can specify a frequency, a modulation method, and the like. Next, using the SF 1704e, the service manager 1704f acquires the PAT from the MPEG-2 transport stream obtained through the tuning. In addition, the program number that corresponds to the specified channel identifier is searched for from the library 1701b, and the corresponding PMT checked. After that, the PID of the PMT, which corresponds to the specified channel, is acquired from the PAT, and using the SF 1704e, the PMTs within the MPEG-2 transport stream are acquired. Note that in the MPEG standard, the version of the PAT and the PMT may be upgraded. Accordingly, the recorded service selection unit 2404 constantly filters and monitors the PAT and PMT, performs the above processing again when the version of either the PAT or the PMT is upgraded, and obtains the PMT corresponding to the specified channel identifier. All PIDs and table_ids of all the ESs denoted in the PMT, or in other words, the audio, video, and section ES that make up the service, are set in the PID filter 1502 and the section filter 1503 of the TS decoder. After that, as shown in FIG. 27, an input and output of the hardware constituent elements are set so that the MPEG-2 transport stream is inputted into the TS decoder via the adapter 1311. Then, in accordance with the flow described in FIG. 27, all ESs that make up a desired service are inputted into the recording area 1504, and are recorded into the recording area 1504 via the time-shift buffer write control unit 1802 described earlier. In addition, the private section that passed through the section conversion unit 2601 is recorded in the recording area 1504 in a format different from that of the buffer area, as has been described above.

At the same time, the specified service from the MPEG-2 transport stream recorded in the recording area 1504 through the above-mentioned procedure is reproduced. In addition, through the library 1701b, the service manager 1704f sets the output destination of each hardware constituent element to flow through the path shown in FIG. 28. After that, the channel identifier of the channel that should be reproduced from the MPEG-2 transport stream outputted from the recording area 1504 is provided to the JMF 1704a. Then, through the process described above, the JMF 1704a commences reproduction of the audio and video multiplexed into the MPEG-2 transport stream outputted from the secondary storage unit 1307. Furthermore, the service manager 1704f provides the channel identifier of the channel that should be reproduced to the AIT monitoring unit 2402 of the AM 1704b. Then, in accordance with the AIT multiplexed into the MPEG-2 transport stream outputted from the secondary storage unit 1307 via the TS decoder 1302, the AM 1704b commences execution and termination of the Java program multiplexed into the same MPEG-2 transport stream.

A typical process of the present embodiment configured as described above is shown hereafter.

First, when the EPG 1702, which is the Java program 1806, calls the createTimeShiftBuffer(intime) which is provided by the time-shift buffer management unit 1801, the time-shift buffer write control unit 1802 commences the recording processing, and the time-shift buffer read control unit 1803 commences the read processing. Next, when the same EPG 1702 calls the select(intservice_id) provided by the service manager 1704f, the MPEG-2 transport stream, as well as the AIT and DSM-CC file system which have been converted from the private section format, are recorded into the recording area 1504 located within the secondary storage unit 1307, or in other words, into the time-shift buffer area, in accordance with the recording processing flow shown in FIG. 27, and furthermore, the same MPEG-2 transport stream, as well as the AIT and DSM-CC file system which have been converted from the private section format, are read out from the recording area 1504, or in other words, from the time-shift buffer area, in accordance with the reproduction processing flow shown in FIG. 28, and the service is reproduced. In the case where the Java program is included within the service, the Java program is executed by the AM 1704b in accordance with the AIT control information.

According to the present embodiment, the configuration of the time-shift buffer implemented by adding a buffer area, rather than through a conventional ring buffer; therefore, it is possible to continue recording without forcefully changing the playback position, even in the case where pause, slow-motion playback, or the like are performed through trick-play. In addition, data sent by the private section that is in a special format is not recorded in MPEG-2 transport stream format, but rather is recorded in a different file format, with overlaps being deleted, and thus it is possible to reduce no the amount of space used up in the secondary storage unit.

It should be noted that in the present embodiment, there is no particular limit on the total number of buffer areas to be secured, but the present embodiment may take on a configuration in which the total number of buffer areas is limited, through a volume limit placed on the secondary storage unit 1307 or the like. In such a case, a configuration may be utilized in which recording can be continued without forcefully changing the reproduction position until the total number of buffer areas reaches the limit, and the reproduction pointer is forcefully moved to the start address of the next buffer only when the total number of buffer areas has reached the limit. Alternatively, the configuration may be one in which the total number of buffer areas is fixed. In addition, the size of each buffer area does not need to be a fixed length, and all buffer areas do not need to be the same size.

(Afterword)

The several embodiments described above indicate embodiments of the present invention, but other embodiments can be considered as long as the intent of the present invention is realized. In addition, a configuration may be one in which main processes of each embodiment are selected and combined. It is possible to replace parts of the above description that are implemented by software with hardware and vice versa.

In the embodiments, an example in which the speed at which the service is reproduced is altered; however, a configuration in which the reproduction position of the service is altered may be used and the same results achieved. In other words, the position of the reproduction pointer changes based on a change in the reproduction position of the service, but this can be considered equivalent to the case where the speed of reproduction is increased in forward or reverse directions.

In the embodiments, a configuration for a cable system has been shown, but the present invention can be applied independent of the type of a broadcast system. For example, the present invention can easily be applied to a satellite system, a ground wave system, or a TV show distribution system that uses an IP network. In addition, as the present invention has no direct relationship with the differences between each broadcast system, the present invention can be applied to an arbitrary transmission medium regardless of the broadcast system. The present invention is also applicable regardless of whether the system is a wired or wireless system.

It is not necessary for the AV decoder to decode video and audio at the same time. The present invention can be implemented even if the AV decoder is configured as separate video and audio decoders. In addition, the AV decoder may have a decoding function for data such as closed captioning and the like without any interference. The audio signal and video signal decoded by the AV decoder may be scrambled at any stage up until being stored in the recording area 1504.

In the embodiments, an example is given in which an adapter so that controls limited viewing has been introduced, but the adapter is not necessary for the implementation of the present invention. The adapter may be of any format, and a configuration without the adapter is also possible. In such a case, in FIG. 15, the MPEG-2 transport stream from the tuner is inputted directly into the TS decoder. The present invention is applicable in such a case ds well. In addition, removal of the limited viewing by the adapter does not necessarily have to be carried out before the TS decoder. A configuration in which the adapter is in an arbitrary position and is used to remove the limited viewing is easily implementable, and the present invention is applicable in such a case as well.

An encoding format into which the AV encoder encodes the audio and video signal may be an arbitrary format. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of the display and speaker.

The present invention can be implemented even if the CPU itself is a system which performs multiple processes, the processes being all or some of TS decoding, AV decoding, AV encoding, and multiplexing.

In addition, a configuration may be used in which there is no need to re-encode the MPEG video and audio when recording, and the MPEG video ES and audio ES inputted from the tuner are written into the recording area as-is without being re-encoded, without losing the effects of the present invention. As a format for recording the service, the MPEG-2 transport stream can also be recorded directly into the recording area after being outputted from the tuner, without passing through the TS decoder; or, the format of the MPEG-2 transport stream from the tuner can be converted, by providing a translator that converts the format of the MPEG-2 transport stream, and recorded into the recording area. The present invention can be implemented regardless of the service recording method.

Some of the Java virtual machines translate the bytecode into an executable form which can be interpreted by the CPU and pass the resultant to the CPU, which executes it; the present invention is applicable in such a case as well.

The above embodiments describe a method for implementation regarding the AIT in which the transport stream is obtained from in-band; however, the method for referring to the lava program which the AM shall execute does not solely depend on the AIT. In OCAP, which is assumed as being used in United States cable systems, XAIT, which is identical to AIT and transmits synchronous data OOB, is used, In addition, methods such as starting a program pre-recorded in the ROM, starting a program downloaded and recorded in the secondary storage unit, and so on can be considered.

A method for recording the DSM-CC file system and the AIT file may be an arbitrary method.

The present invention can be implemented even if a method in which the AIT section is filtered and acquired from the MPEG-2 transport stream and a method in which the DSM-CC section is recorded in a file in a unique format are combined. In addition, the present invention can be implemented even if a method in which the DSM-CC section is filtered and acquired from the MPEG-2 transport stream and a method in which the AIT section is recorded in a file in a unique format are combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A recording and reproduction apparatus and recording and reproduction method according to the present invention can be applied in the consumer electronics industry as an apparatus for recording and reproducing a broadcast. For example, the present invention is applicable to cable STB, digital TV, and the like. Furthermore, the present invention is also applicable in devices with a broadcast receiving function, such as, for example, a cellular phone device and the like.

1. A recording and reproduction apparatus comprising:
a recording buffer in which plural buffer areas used in recording and reproducing content are connected in a linear list;
a recording pointer which indicates a position in said recording buffer at which the content is recorded;
a reproduction pointer which indicates a position in said recording buffer at which the content is reproduced;
a content recording control unit operable, in the case where recording of the content has progressed and said recording pointer has passed the end of the last buffer area, to create a new buffer area connected to the end of said recording buffer in the linear list, and to position said recording pointer at the start of the newly-created buffer; and
a content reproduction control unit operable, in the case where reproduction of the content has progressed and said reproduction pointer has passed the end of a buffer area, to delete the buffer, and to position said reproduction pointer at the start of the next buffer area connected in the linear list.

2. A recording and reproduction apparatus comprising:
a recording buffer in which plural buffer areas used in recording and reproducing content are connected in a linear list;
a recording pointer which indicates a position in said recording buffer at which the content is recorded;
a reproduction pointer which indicates a position in said recording buffer at which the content is reproduced;
a content recording control unit operable, in the case where recording of the content has progressed and said recording pointer has passed the end of the last buffer area, to create a new buffer area connected to the end of said recording buffer in the linear list, and to position said recording pointer at the start of the newly-created buffer; and
a content reproduction control unit operable, in the case where reproduction of the content has progressed and said reproduction pointer has passed the end of a buffer area, and the content needs to be reproduced for a length of time even if the buffer area is deleted, to delete the buffer, and to position said reproduction pointer at the start of the next buffer area connected in the linear list.

3. The recording and reproduction apparatus according to claim 1,
wherein said content recording control unit is further operable, in the case where recording of the content has progressed and said recording pointer has passed the end of the last buffer area, and the upper limit of the total number of buffers is not exceeded even if a new buffer area is created, to create a new buffer area connected to the end of said recording buffer in the linear list, and to position said recording pointer at the start of the newly-created buffer.

4. The recording and reproduction apparatus according to claim 1, further comprising
a format conversion recording unit operable to convert the format of a specified part of the content and record the specified part of the content in association with the buffer area that corresponds to the period in which the specified part of the content was sent,
wherein the content is recorded into the recording buffer with the exception of the specified part of the content; and
when reproducing, from the recording buffer, the content with the exception of the specified part of the content, the specified part of the content recorded into said format conversion recording unit is reproduced simultaneously in accordance with the time at which said reproduction pointer is positioned.

5. The recording and reproduction apparatus according to claim 1, further comprising
a receiving unit operable to receive a broadcast,
wherein the content is the entirety of an MPEG-2 transport stream received by said receiving unit.

6. The recording and reproduction apparatus according to claim 1, further comprising
a program downloading unit operable to download a program; and
a content recording control start unit operable to start a process of said content recording control unit based on an instruction from the program.

7. The recording and reproduction apparatus according to claim 1, further comprising
a reproduction speed and position change unit operable to change the movement speed and position of said reproduction pointer based on an instruction from the program.
